(19) United States
(12) Patent Application Publication
(10) Pub. No.: US 2026/0105670 A1
(43) Pub. Date: Apr. 16, 2026

(54) GENERATING CUSTOM ANIMATIONS UTILIZING GENERATIVE ARTIFICIAL INTELLIGENCE

(71) Applicant: Adobe Inc., San Jose, CA (US)

(72) Inventors: Yangtuanfeng Wang, London (GB); Li-Yi Wei, Redwood City, CA (US); Wilmot Wei-Mau Li, San Jose, CA (US); Valerie Head, Pittsburgh, PA (US); Seth Walker, San Francisco, CA (US); Lakshya Lnu, San Jose, CA (US); Kshitiz Garg, Santa Clara, CA (US); Kazi Rubaiat Habib, Seattle, WA (US); Jun Saito, Seattle, WA (US); James Ratliff, Seattle, WA (US); Duygu Ceylan Aksit, Mountain View, CA (US); Dafei Qin, San Jose, CA (US); Cameron Smith, Santa Cruz, CA (US)

(21) Appl. No.: 19/344,926

(22) Filed: Sep. 30, 2025

Related U.S. Application Data
(60) Provisional application No. 63/707,077, filed on Oct. 14, 2024.

(51) Int. Cl. G06T 13/20; G06T 5/60; G06T 5/70

(52) U.S. Cl. CPC G06T 13/20; G06T 5/60; G06T 5/70

(57) ABSTRACT

Systems, methods, and non-transitory computer-readable media generate custom animations comprises a structure of a coarse animation prompt. For example, the disclosed systems receive a style prompt and receive a coarse animation prompt. The disclosed systems generate, utilizing a media generation model, a custom animation having a structure and timing of the coarse animation prompt and a style informed by the style prompt. The disclosed systems also provide the custom animation for display via a graphical user interface.

### CROSS REFERENCE TO RELATED APPLICATIONS

This application claims the benefit of and priority to U.S. Provisional Application No. 63/707,077, filed Oct. 14, 2024. The aforementioned application is hereby incorporated by reference in its entirety.

### BACKGROUND

Recent years have seen significant advancement in hardware and software platforms for performing generative tasks. Indeed, generative models fundamentally improve the way users author image and videos by streamlining the creation process utilizing deep learning. Despite the advances in generative models, conventional systems suffer from a number of deficiencies with regards to efficiency and operational flexibility.

### SUMMARY

One or more embodiments described herein provide benefits and/or solve one or more problems in the art with systems, methods, and non-transitory computer-readable media that implement a generative animation pipeline that enables users to create custom animations from coarse, low-fidelity input. For example, in one or more implementations, the generative animation pipeline receives a black-and-white motion guidance video (or other coarse motion guidance) that specifics a desired spatial structure and timing for a custom animation. The coarse motion guidance comprises two-dimensional (2D) or three-dimensional (3D) spatial information, which enables control over 2D or 3D motion. Additionally, the generative animation pipeline allows users to provide a text prompt and/or a reference image to indicate desired content and visual style of the custom animation. The generative animation pipeline utilizes one or more media generation models (e.g., diffusion networks) to generate a custom animation based on the coarse motion guidance and other inputs. Thus, the generative animation pipeline allows for different input control modalities to create animations and motion graphics using various generative models. Additionally, the generative animation pipeline enables users, including both novices and professionals, to create custom motion graphics with ease, control, and expressiveness.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a custom animation generation system operates in accordance with one or more implementations;

FIG. 2 illustrates the custom animation generation system generating a custom animation from a coarse motion prompt and a text prompt in accordance with one or more implementations;

FIG. 3 illustrates a diagram of training a text-to-video diffusion model and generating a video utilizing the trained text-to-video diffusion model in accordance with one or more implementations;

FIG. 4 illustrates a diffusion model with structure conditioning in accordance with one or more implementations;

FIGS. 5A-5E illustrate a graphical user interface provided by the custom animation generation system displaying the generation of a custom animation from a coarse motion prompt and a text prompt in accordance with one or more implementations;

FIGS. 6A-6C illustrate a graphical user interface provided by the custom animation generation system displaying the generation of a custom animation from a coarse animation prompt and a text prompt with increased weight on the coarse animation prompt in accordance with one or more implementations;

FIG. 7 illustrates a graphical user interface provided by the custom animation generation system displaying the generation a custom 3D animation from a coarse motion prompt in the form of a depth map and a text prompt in accordance with one or more implementations;

FIG. 8 illustrates the custom animation generation system generating a custom animation from a coarse motion prompt, an image prompt, and a text prompt in accordance with one or more implementations;

FIG. 9 illustrates additional details of the custom animation generation system generating a custom animation from a coarse motion prompt, an image prompt, and a text prompt in accordance with one or more implementations;

FIGS. 10A-10C illustrate a graphical user interface provided by the custom animation generation system displaying the generation of a custom animation from a coarse motion prompt, and image prompt, and a text prompt with increased weight on the coarse motion prompt in accordance with one or more implementations;

FIG. 11 illustrates the custom animation generation system providing a custom animation as a layer in a digital video in accordance with one or more implementations;

FIG. 12 illustrates the custom animation generation system generating a custom animation utilizing a transformer-based diffusion model in accordance with one or more implementations;

FIGS. 13A-13B illustrate diagrams of the custom animation generation system utilizing spatial-temporal positional encodings to further control spatial and/or temporal weighting of structural conditioning in accordance with one or more implementations;

FIG. 14 illustrates a diagram of the custom animation generation system processing, using a transformer block, noised tokens with spatial-temporal positional encodings to generate a custom animation with spatial and/or temporal weighting of structural conditioning in accordance with one or more implementations;

FIG. 15 illustrates a series of acts for generating a custom animation with structural conditioning in accordance with one or more implementations;

FIG. 16 illustrates an example of a guided diffusion model in accordance with one or more embodiments;

FIG. 17 illustrates an example of a U-Net in accordance with one or more embodiments;

FIG. 18 illustrates an example of a method for conditional media generation in accordance with one or more embodiments;

FIG. 19 illustrates an example of a diffusion process in accordance with one or more embodiments;

FIG. 20 illustrates a flow diagram depicting an algorithm as a step-by-step procedure for training a machine-learning model in accordance with one or more embodiments;

FIG. 21 illustrates an example of a method for training a diffusion model in accordance with one or more embodiments;

FIG. 22 illustrates an example of a custom animation generation system apparatus in accordance with one or more embodiments; and

FIG. 23 illustrates a block diagram of an example computing device in accordance with one or more embodiments.

### DETAILED DESCRIPTION

One or more embodiments includes a custom animation generation system that generates custom animations from coarse, low-fidelity input. For example, in one or more implementations, the custom animation generation system receives a black-and-white motion guidance video (or other coarse motion guidance) that specifics a desired spatial structure and timing for a custom animation. The coarse motion guidance comprises two-dimensional (2D) or three-dimensional (3D) spatial information, which enables control over 2D or 3D motion. Additionally, the custom animation generation system allows users to provide a text prompt and/or a reference image to indicate desired content and visual style of the custom animation. The custom animation generation system utilizes one or more media generation models (e.g., diffusion models) to generate a custom animation based on the coarse motion guidance and other inputs. Thus, the custom animation generation system allows for different input control modalities to create animations and motion graphics using various generative models. Additionally, the custom animation generation system enables users, including both novices and professionals, to create custom motion graphics with ease, control, and expressiveness.

As mentioned above, conventional systems suffer from a variety of issues related to accuracy, efficiency, and operational flexibility. Specifically, conventional systems suffer from computational inaccuracies. For example, conventional systems generate image or video from a user-provided text prompt, however conventional systems suffer from generating content that does not have a strong text and image/video semantic alignment (e.g., conventional systems generate inaccurate media that does not align with a user-provided prompt). Furthermore, the content generated by conventional systems is typically low-quality pixel content. In addition, conventional systems use various methods to encode the spatial and temporal relationship among frames of a video that correspond to visual tokens. However, for video generation, conventional systems use methods that create misalignments (e.g., between video frames and video captions) which leads to confusion and inaccuracies during training a model. For instance, conventional systems generate distorted or misaligned frames in a video that are not aesthetically pleasing. In other words, conventional systems that encode spatial and temporal relationships often suffer from generating low-quality frames and/or compromised frames that fail to capture the subject of the request.

As mentioned above, conventional systems further suffer from computational inefficiencies. For example, conventional systems that perform image and video generation typically suffer from consuming a high number of resources. Specifically, conventional systems waste a large amount of time and computing resources to train a diffusion model from scratch. For instance, any updates performed on a model for capturing motion information requires conventional systems to train a diffusion model from the bottom up (e.g., from scratch). As such, conventional systems consume a lot of resources to prepare models for media generation tasks but still perform generative tasks in an inaccurate and inefficient manner.

Moreover, conventional systems suffer from further inefficiencies by using complicated transformer-based architectures. Specifically, in order for conventional systems to generate video and image content, conventional systems typically require domain specific complexity for the model architecture to capture all the domain specific data. Accordingly, conventional systems require a lot of time and resources to run a model that generate content across domains.

Relatedly, conventional systems suffer from operational inflexibilities. For example, due to the various inaccuracies and inefficiencies described above, conventional systems struggle to provide robust generative media content in response to a media generation request. Specifically, conventional systems generate low-quality video that fails to conform with user-specified requests, and conventional systems further consume a vast number of resources and time to generate the low-quality video.

In one or more embodiments, the custom animation generation system provides one or more improvements over conventional systems in relation to accuracy, efficiency, and operational flexibility. In contrast to conventional systems which do not have a strong text and image/video semantic alignment, in one or more embodiments, the custom animation generation system improves upon accuracy by using a diffusion transformer model architecture that effectively captures semantic alignment across modalities (e.g., text, image, and video). Specifically, the custom animation generation system provides for spatial control of a generated animation. The custom animation generation system generates an animation that selectively maintains a correspondence level with a spatial structure from a coarse animation prompt. As explained in greater detail below, the custom animation generation system includes a structure control branch that injects signals into the diffusion model to help ensure that a custom animation generated by the diffusion model maintains the spatial structure of the coarse animation prompt.

Relatedly, the custom animation generation system improves upon flexibility. Specifically, the custom animation generation system provides for generation of two-dimensional or three-dimensional custom animations that maintain a timing and structure of a course input. However, the custom animation generation system also allows a user to provide a text prompt and/or a style image prompt to further condition the generation of the custom animation. As such, the custom animation generation system allows a user to control the style, structure, and timing of a custom animation while still having the custom animation be AI generated. In addition to controlling the style, timing, and structure of a custom animation, the custom animation generation system allows a user to control a balance between how much weight the system gives the structure from the coarse animation prompt versus the stylization from a text or image prompt.

Furthermore, the custom animation generation system provides operation flexibility beyond the capabilities of prior art systems. For example, the custom animation generation system supports generation of 2D and 3D animations with custom animation, style, etc. Specifically, the custom animation generation system allows for two-dimensional animations or three-dimensional animation based on the coarse animation prompt.

Additionally, the custom animation generation system provides further operation flexibility beyond the capabilities of prior art systems. For example, the custom animation generation system supports allows a user to select spatial and/or temporal locations to which greater or lesser weight is given to the structural conditioning. In this manner, the custom animation generation system allows a user to specify spatial and/or time locations that should strongly correspond to the coarse animation prompt, while allowing the system more creativity in other parts of the custom animation.

Additionally, the custom animation generation system demonstrates strong performance of generating accurate image/video that has strong text and image/video semantic alignment (e.g., the generative content is responsive to a user-provided prompt). Specifically, while generating a custom animation using generative AI, the custom animation generation system nonetheless performs the custom generation in a manner that maintains fidelity to user inputs. For example, the custom animation generation system generates custom animations that maintain the timing and structure of a coarse animation prompt and the style from a text or image prompt.

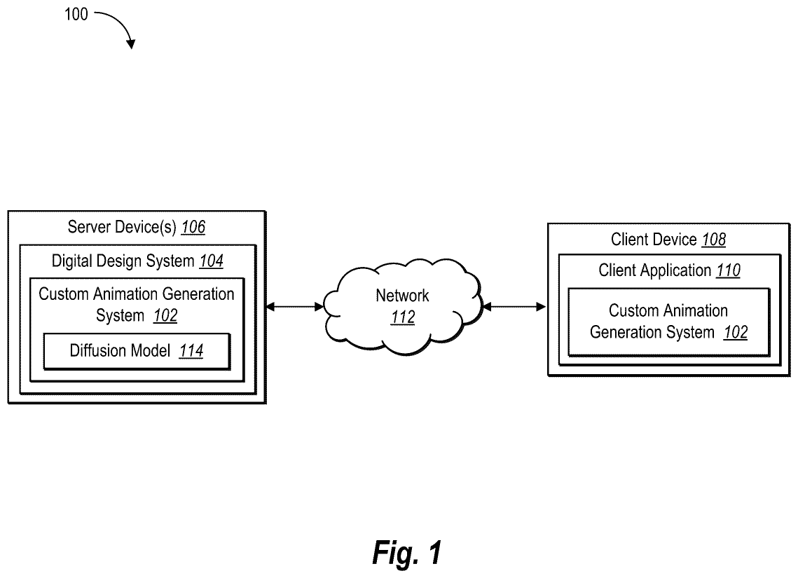

Additional details regarding the custom animation generation system will now be provided with reference to the figures. For example, FIG. 1 illustrates a schematic diagram of an exemplary system environment 100 in which a custom animation generation system 102 operates. As illustrated in FIG. 1, the system environment 100 includes server devices(s) 106, a digital design system 104, a network 112, and a client device 108. Additionally, FIG. 1 illustrates that the digital design system 104 includes the custom animation generation system 102. As shown, the custom animation generation system 102 includes a diffusion model 114.

Although the system environment 100 of FIG. 1 is depicted as having a particular number of components, the system environment 100 is capable of having a different number of additional or alternative components (e.g., a different number of server devices, client devices, or other components in communication with the custom animation generation system 102 via the network 112). Similarly, although FIG. 1 illustrates a particular arrangement of the server device(s) 106, the network 112, and the client device 108, various additional arrangements are possible.

The server device(s) 106, the network 112, and the client device 108 are communicatively coupled with each other either directly or indirectly (e.g., through the network 112). Moreover, the server device(s) 106 and the client device 108 include one or more of a variety of computing devices (including one or more computing devices as discussed in greater detail below).

As mentioned above, the system environment 100 includes the server device(s) 106. In one or more embodiments, the server device(s) 106 process input for a custom animation request or for training one or more artificial intelligence models. In one or more embodiments, the server device(s) 106 comprise a data server. In some implementations, the server device(s) 106 comprise a communication server or a web-hosting server.

In some embodiments, the client device 108 includes computing devices associated with the one or more user accounts that submit media generations requests to the custom animation generation system 102 to generate custom animations (e.g., based on a text prompt and/or a coarse animation prompt). In one or more embodiments, the client device 108 includes smartphones, tablets, desktop computers, laptop computers, head-mounted-display devices, or other electronic devices. The client device 108 includes one or more software applications (e.g., the client application 110 includes a digital editing application) for generating content in accordance with the digital design system 104. In one or more embodiments, the client application 110 includes a software application hosted on the server device(s) 106 accessible by the client device 108 through another application, such as a web browser.

To provide an example implementation, in some embodiments, the custom animation generation system 102 on the server device(s) 106 supports the custom animation generation system 102 on the client device 108. For instance, in some cases, the digital design system 104 on the server device(s) 106 trains the machine learning models of the custom animation generation system 102. In response, the custom animation generation system 102, via the server device(s) 106, provides the trained machine learning models to the client device 108. In other words, the client device 108 obtains (e.g., downloads) the custom animation generation system 102 from the server device(s) 106. Once downloaded, the custom animation generation system 102 on the client device 108 provides tools for generating a custom animation independent from the server device(s) 106.

In alternative implementations, the custom animation generation system 102 includes a web hosting application that allows the client device 108 to interact with content and services hosted on the server device(s) 106. To illustrate, in one or more implementations, the client device 108 access a software application supported by the server device(s) 106. The custom animation generation system 102 on the server device(s) 106 provides tools for inputting instructions to generate a custom animation based on input received via the client device 108.

Indeed, in some embodiments, the custom animation generation system 102 is implemented in whole, or in part, by the individual elements of the system environment 100. For instance, although FIG. 1 illustrates the custom animation generation system 102 implemented or hosted on the server device(s) 106, different components of the custom animation generation system 102 are able to be implemented by a variety of devices within the system environment 100. For example, one or more (or all) components of the custom animation generation system 102 are implemented by a different computing device or a separate server from the server device(s) 106. Indeed, as shown in FIG. 1, the client device 108 includes the custom animation generation system 102.

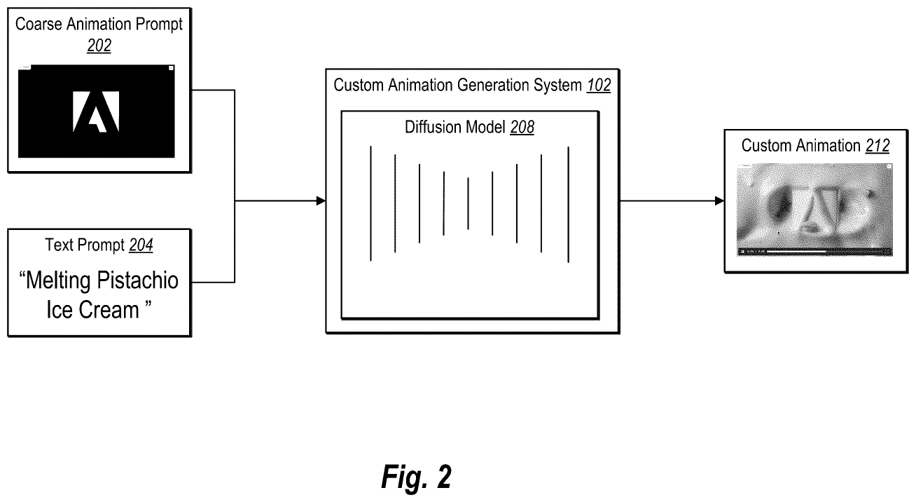

As mentioned above, the custom animation generation system 102 generates custom animations in response to a media generation request by using a diffusion model 208. As shown in FIG. 2, the custom animation generation system 102 receives a coarse animation prompt 202 and optionally a text prompt 204. In one or more implementations, the custom animation generation system 102 receives a request in the form of a prompt from a client device to generate a custom animation that conforms with the prompts. To illustrate, the prompts 202, 204 includes specific media attributes (e.g., media parameters or media settings) for the custom animation generation system 102 to generate within the custom animation 212. Specifically, the custom animation generation system 102 utilizes a diffusion model 208 conditioned on the prompts 202, 204 to generate the custom animation 212.

In one or more implementations, the coarse animation prompt 202 comprises an indication of a desired animations timing, transitions, and/or structure. For example, a coarse animation prompt, in one or more implementations, comprises a simplified or coarse animation or video. Specifically, in one or more implementations, the coarse animation prompt 202 comprises a black and white animation lacking texture, key frames defining desired poses or states, outlines of shapes, depth maps, or other input with reduced or minimal detail.

A coarse animation prompt is coarse as compared to a custom animation generated therefrom. For example, a coarse animation prompt, in one or more implementations, is coarse in that it includes fewer colors, textures, and/or stylization than a custom animation generated therefrom. As another example, a coarse animation prompt, in one or more implementations, is coarse in that comprises a resolution less than a resolution of a custom animation generated therefrom. For instance, a coarse animation prompt, in one or more implementations, comprises a resolution of 1080p or less while a resolution of a custom animation generated therefrom is greater than 1080p (e.g., 4k or 8k).

As mentioned, the custom animation generation system 102 generates custom animations that includes a digital image or a digital video. For example, a video refers to a form of media that is encoded and stored in a digital format. Specifically, a video includes a sequence of frames (e.g., images, keyframes, and/or motion frames) and each frame of the sequence of frames is displayed sequentially. For instance, a video includes a specific resolution (480p, 720p, 1080p, 4K, etc.) which refers to a specific number of pixels being displayed (e.g., a video's resolution defines the clarity and sharpness of the video). Further, a video includes a frame rate (e.g., a number of frames shown per second in a video e.g., 24 fps, 30 fps, etc.), an aspect ratio (e.g., the width and height dimensions of a frame, such as 16:9 or 4:3), compression (e.g., a file size of the video), and audio that goes along with the video (e.g., audio files that are synchronized with frames of the video).

In one or more embodiments, a digital image includes various pictorial elements. In particular, the pictorial elements include pixel values that define the spatial and visual aspects of the digital image such as text and image objects. For example, the digital image is a rasterized image which includes a grid of pixels. In particular, the rasterized image includes a fixed resolution as determined by a number of pixels within the digital image. In some instances, the custom animation generation system 102 generates a vectorized image which refers to a type of digital image represented by mathematical equations, rather than pixels. Specifically, vectorized images are composed of geometric shapes (e.g., lines, points, curves) and in one or more embodiments are resized indefinitely without loss of quality.

In addition to controlling one or more features of the custom animation 212 via the coarse animation prompt 202, the custom animation generation system 102 also optionally utilizes the text prompt 204 to control style, content, textures, and other visual features of the custom animation 212. For example, as shown by FIG. 2, the custom animation 212 includes the general structure, timing, and length of the coarse animation prompt 202 but in the style for the custom animation is included in the text prompt 204 (e.g., melting pistachio ice cream).

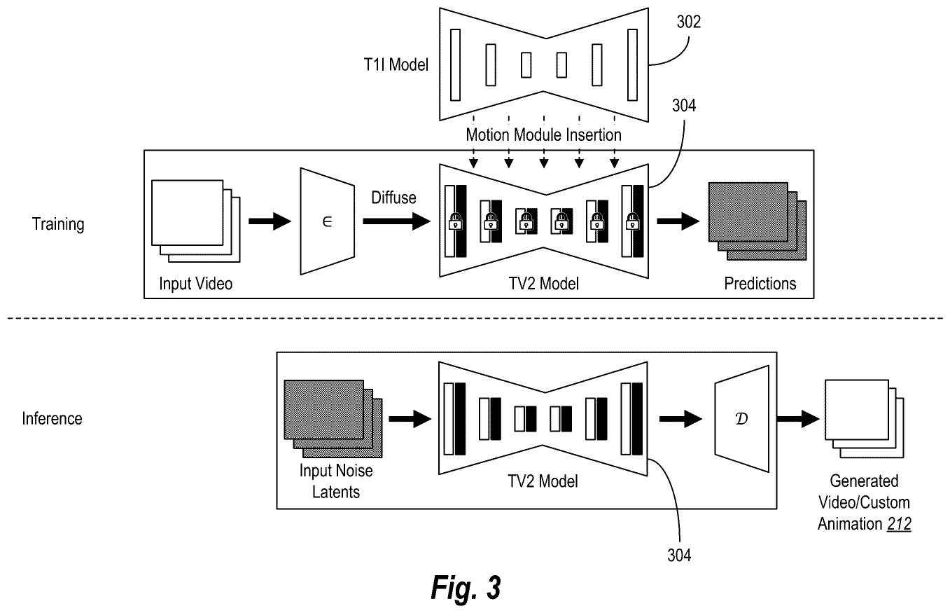

As shown by FIG. 3, the diffusion model is generated from a pretrained text-to-image model (T2I diffusion model) 302. Specifically, the diffusion model (e.g., the text-to-video diffusion model T2V 304) is generated by interleaving the temporal blocks in the T2I diffusion model 302. The temporal layers are a combination of temporal convolutions and temporal attentions. During training, the custom animation generation system 102 freezes the spatial layers to preserve creativeness and image quality of the T2I diffusion model 302. With the spatial layers frozen, the custom animation generation system 102 trains the temporal layers to learn motion, object, shapes, etc.

Specifically, the custom animation generation system 102 trains the temporal layers to learn reasonable motion priors from videos, and particularly animations. Indeed, the custom animation generation system 102 generates temporal layer that learn generalized motion priors. Once trained, the custom animation generation system 102 enable other personalized T2Is to generate smooth and appealing animations aligned with personalized domains by inserting the temporal layers with the spatial layers. Once trained, the diffusion model progressively transforms random noise into structured, meaningful content (in this case, frames of the custom animation 212).

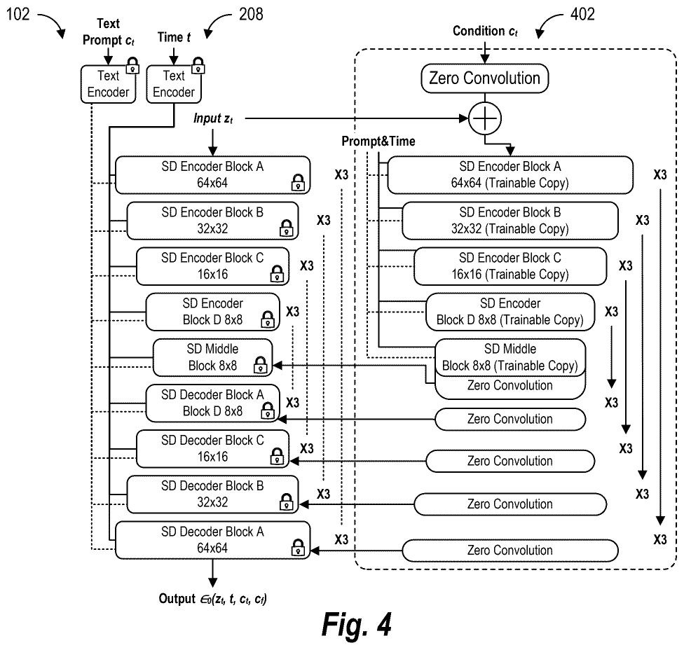

The custom animation generation system 102 combines the trained T2V model 304 with structure control layers. The structure control layers comprising condition layers in a branch that injects structure control signals into the layers of the diffusion model 208 to help ensure that the custom animation 212 comprises the structure (shapes, timing, length) of the coarse animation prompt 202. Specifically, the custom animation generation system 102 encodes the frames/images of the coarse animation prompt 202 into feature tensors via a pretrained feature encoder. The custom animation generation system 102 then combines (e.g., concatenates) the feature tensors together with the video latent and passes them through a structure control branch 402 as shown in FIG. 4. During diffusion steps, the custom animation generation system 102 injects control signals from the structure control branch 402 into corresponding layers of the diffusion model 208 (e.g., the T2V model 304) to bring the residual to the latent signal.

Specifically, as shown in FIG. 4, the custom animation generation system 102 comprises a diffusion model 208 and a structure control branch 402. In one or more implementations, the diffusion model and the structure control branch 402 comprises machine learning models. In one or more embodiments a machine learning model includes a computer algorithm or a collection of computer algorithms that is trained and/or tuned based on inputs to approximate unknown functions. For example, a machine learning model includes a computer algorithm with branches, weights, or parameters that changed based on training data to improve for a particular task. Thus, a machine learning model utilizes one or more learning techniques to improve in accuracy and/or effectiveness. Example machine learning models include various types of decision trees, support vector machines, Bayesian networks, random forest models, or neural networks (e.g., deep neural networks).

Specifically, the diffusion model 208 and a structure control branch 402 comprise neural networks (or layers of neural networks). A neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a transformer, or a multi-layer perceptron. In some embodiments, a neural network includes a combination of neural networks or neural network components.

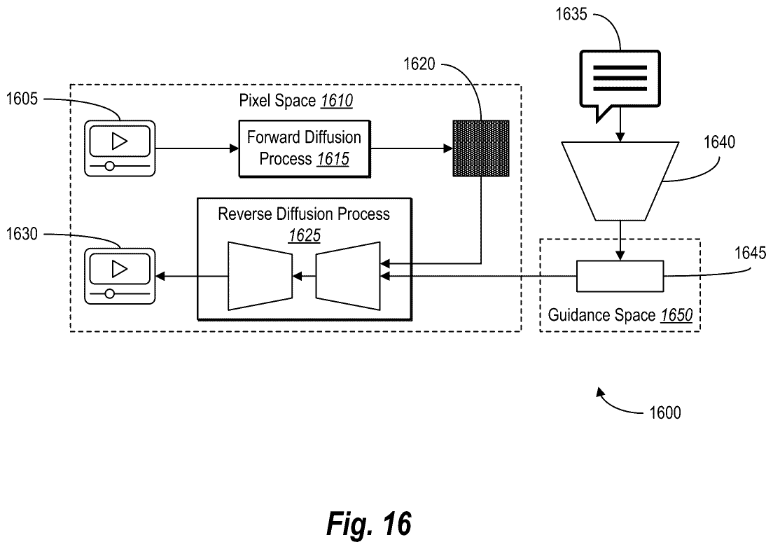

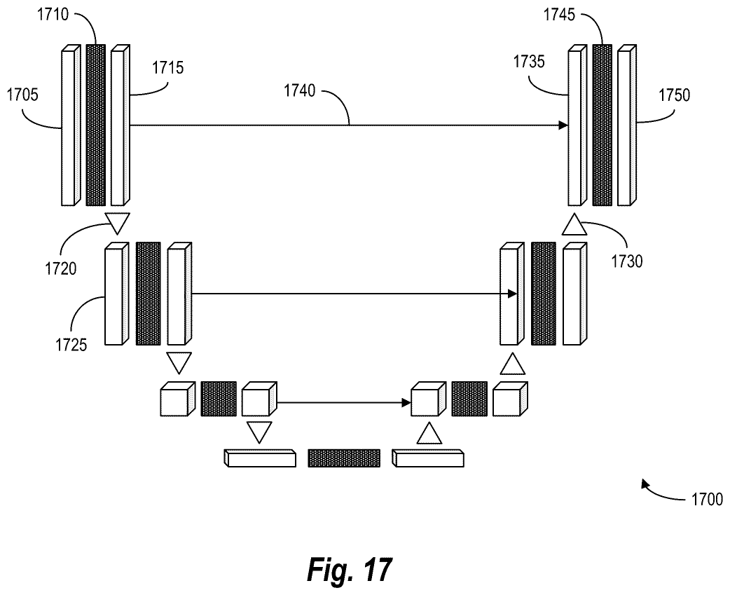

In one or more embodiments, a diffusion model refers to a generative machine learning model that reconstructs data by removing noised input data. More details of diffusion models are provided below in connection with FIGS. 16-22. In one or more embodiments, the diffusion model 208 comprises a U-net architecture as shown in FIG. 4 and described in greater detail in relation to FIG. 17.

In one or more alternative embodiments, the custom animation generation system 102 utilizes a diffusion transformer model. Specifically, the diffusion transformer model refers to a model architecture that leverages principles of diffusion models with a transformer architecture. For example, the diffusion transformer model includes deep learning self-attention mechanisms that process sequential data. For instance, the diffusion transformer model establishes relationships between elements in a sequence using self-attention mechanisms. To illustrate, the custom animation generation system 102 utilizes the diffusion transformer model to denoise noised representations (e.g., noised tokens) to reconstruct data and generate media (e.g., video, images, text, etc.).

As shown in FIG. 4, the diffusion model 208 receives a text prompt cₜ. The custom animation generation system 102 encodes the text prompt cₜ utilizing a text encoder. The custom animation generation system 102 also encodes diffusion timesteps t with a time encoder using positional encoding. The diffusion model 208 conditions the diffusion of a noise input zᵢ based on the encoded text prompt and the encoded timesteps. When using a style reference image, during each step of diffusion, a cross attention between the style feature and the UNet layer is applied for a pre-defined set of layers. This operation adopts the visual features from the style reference image to the generated video sequence. In one or more implementations, the custom animation generation system 102 provides stronger effects by adding more layers to the pre-defined set of layers for such attention injections.

During diffusion, the control branch 402 injects additional conditions into the diffusion model 208 to condition the generation of the custom animation and to control the structure and timing of a custom animation. As noted above, the condition fed to the control branch (c) 402 comprises a coarse animation prompt 202. In one or more embodiments, the custom animation generation system 102 provides the coarse animation prompt 202 as binary mask frames, a depth map, an edge map, or in another form. In any event, as mentioned above, the encodes the frames/images of the coarse animation prompt 202 into feature tensors via a pretrained feature encoder. The control branch (c) 402 applies the condition to teach encoder level of the diffusion model 208.

In one or more embodiments, the custom animation generation system 102 provides for control of strength between inputs provided to the diffusion model 208 (e.g., a text prompt or an image prompt) versus those provided via the control branch 402. Specifically, to allow the control of strength, a strength value between 0 to 1 is multiplied to the residual for each layer from the aforementioned control branch 402. By setting the strength to 0, the control signal will vanish so the generation is not conditioned by the depth or edge structure guidance from the coarse animation input. By setting the strength to 1, the control signal from the control branch 402 is fully applied.

In one or more implementations, instead of controlling the strength of the guidance from the control branch 402 by a single value, the custom animation generation system 102 applies spatial varying control via a 2D weight map. During the denoising steps, once the custom animation generation system 102 generates the control residual, the custom animation generation system 102 resizes the 2D weight map accordingly and multiplies the 2D weight map to the residual tensor (note that the dimension of the residual tensor will be different for different layers). After enhancing the control signal with the spatial varying weight map, the injection will be the same as the spatial control operation.

As shown in FIG. 4, the control branch (c) 402 copies the weights of the neural network blocks of the locked diffusion model 208 while the trainable copy learns the condition. Because the locked parameters are frozen, no gradient computation is required in the originally locked encoder for the finetuning. This approach speeds up training and saves GPU memory. Also, the use of the trainable copy ensures that the layers of the diffusion model 208 are preserved. The zero convolution is a 1×1 convolution with both weight and bias initialized as zero. The custom animation generation system 102 fine tunes the control branch 402.

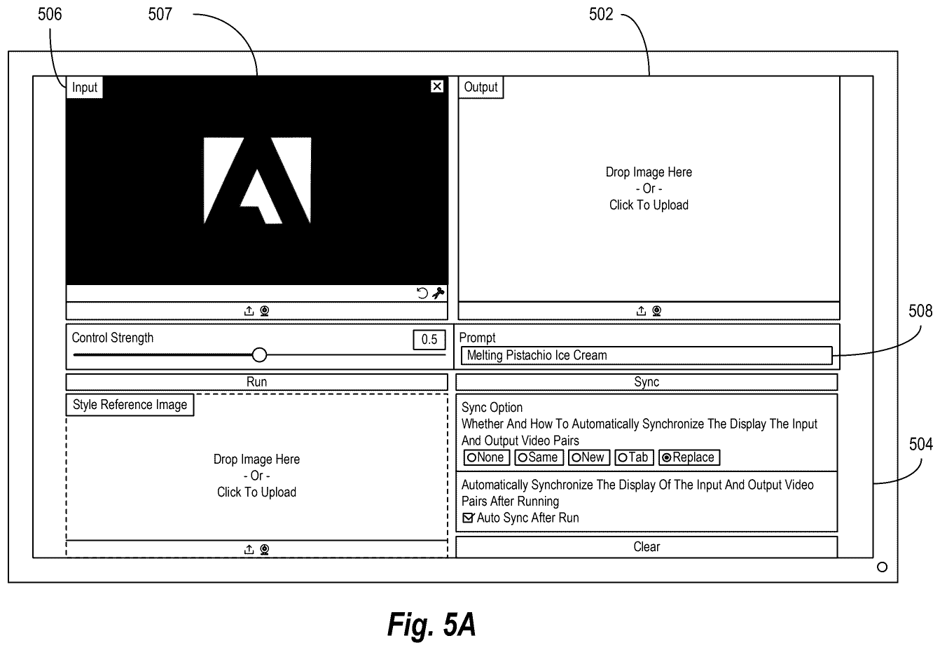

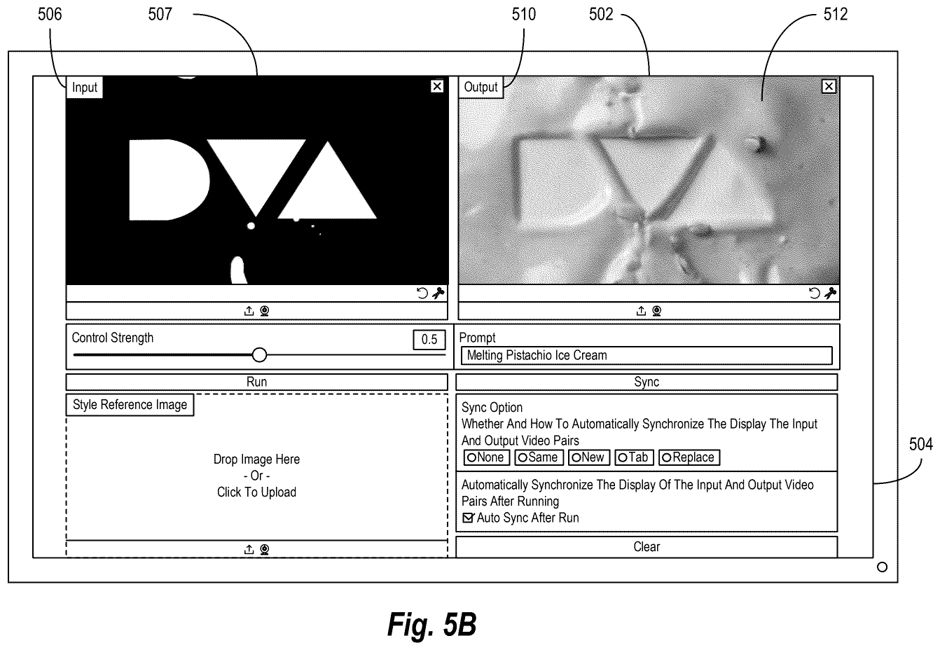

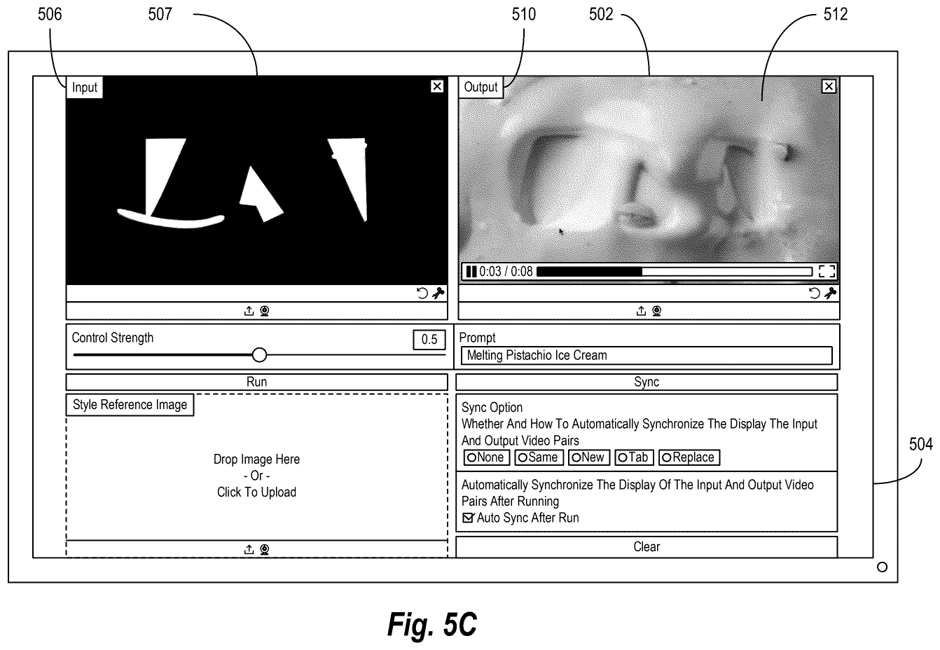

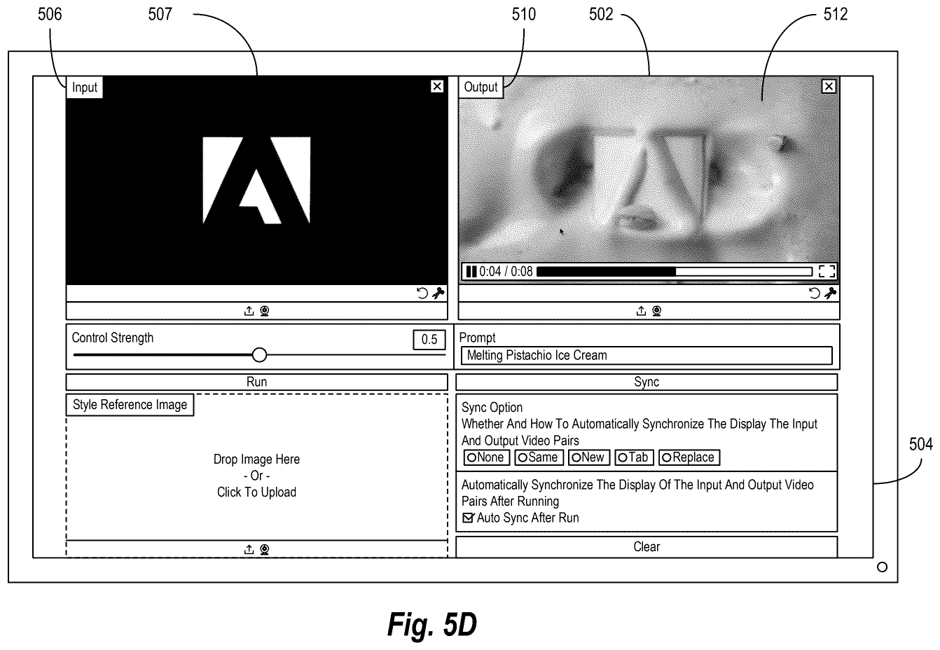

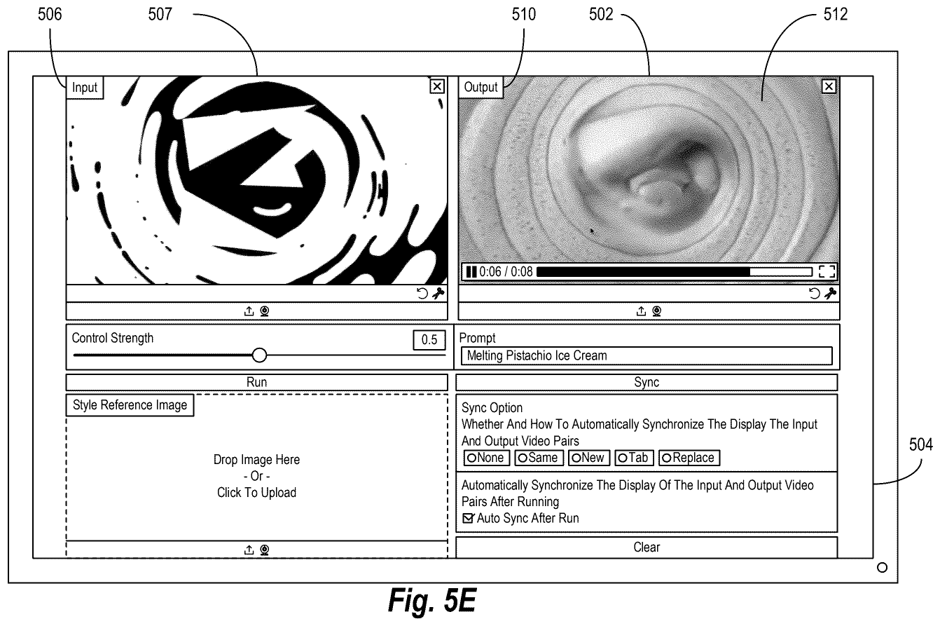

FIGS. 5A-5E illustrate a graphical user interface 502 provided by the custom animation generation system 102 and displayed by a computing device 504 with which a user interacts to generate a custom animation. As shown, the graphical user interface 502 includes an input field 506 for uploading a coarse animation prompt, a text prompt field 508 for entering a text prompt. As shown, in FIG. 5A, the user uploads a coarse animation prompt 507 comprising a short black and video animated video including a logo via the input field 506. Additionally, as shown in FIG. 5A, the user enters a text prompt of “melting Pistachio Ice Cream” in the text prompt field 508.

As shown in FIGS. 5B-5E, based on the coarse animation prompt and the text prompt, the custom animation generation system 102 generates a custom animation 512 that includes the structure, timing, and length of the coarse animation prompt 507 and a texture, color, and style as informed by the text prompt. The custom animation generation system 102 displays the custom animation 512 in an output field 510 of the graphical user interface 502. Furthermore, as shown in FIGS. 5B-5E, the custom animation 512 has finer details than the coarse animation prompt 507, including warping, lighting effects, texture, color, and other stylistic effects. Specifically, FIGS. 5B-5E show different frames of both the coarse animation prompt 507 and the custom animation 512. The comparison of which show that the custom animation generation system 102 generates the custom animation 512 that includes the structure (shapes, logos, lines) of the coarse animation prompt 507 and a texture (ice cream texture), color (green), and style as informed by the text prompt.

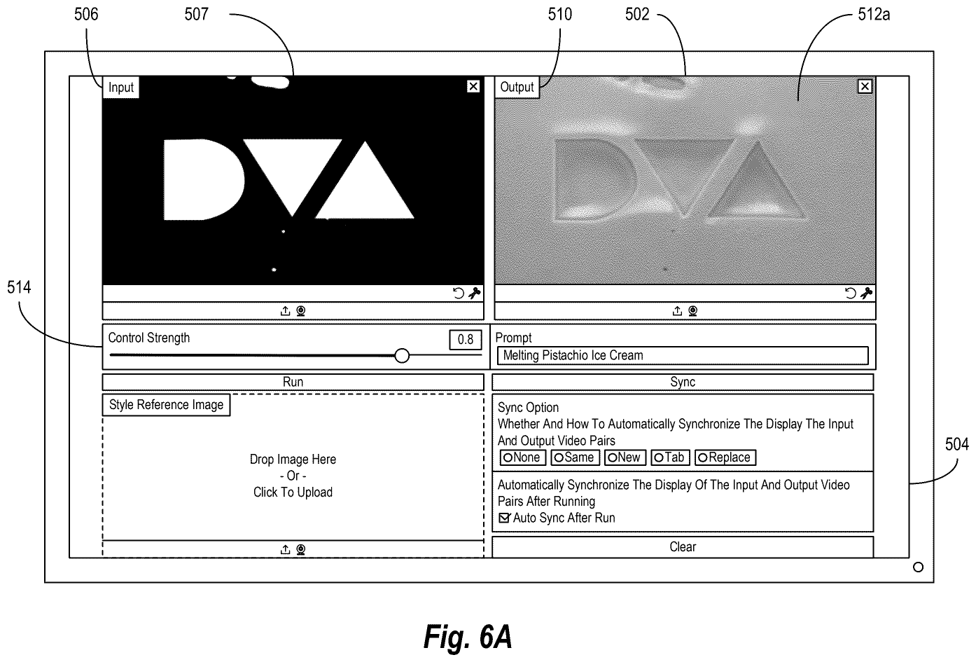

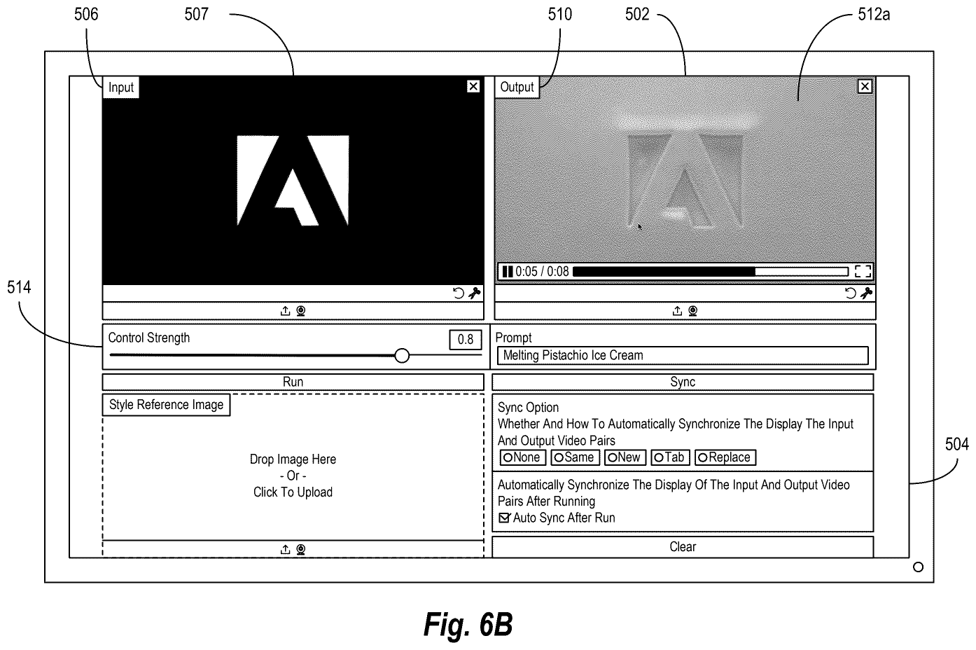

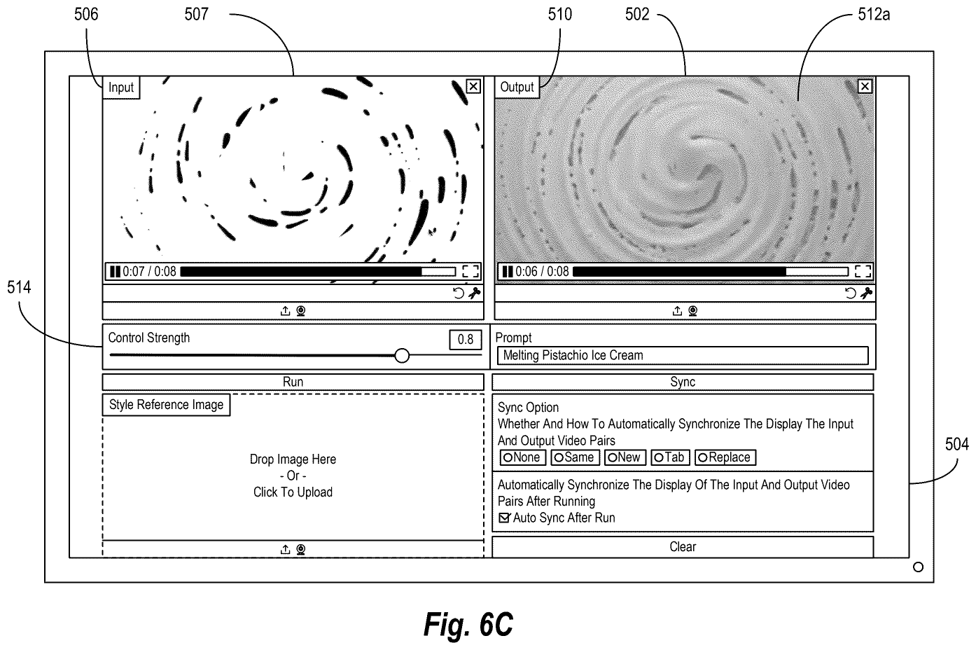

In one or more implementations, the custom animation generation system 102 allows a user to specify how much weight to give to the text prompt versus the coarse animation prompt. For example, as shown in FIGS. 6A-6C, the graphical user interface 502 includes a control strength slider 514. The user can move the control strength slider 514 to a first side to increase the weight given to the structure of the coarse animation prompt as shown by FIG. 6A. The custom animation generation system 102 regenerates the custom animation 512a but this time ensuring that the custom animation 512a more closely follows the structure (edges) of the coarse animation prompt 507 as shown by a comparison of FIGS. 5A-5E to 6A-6C.

FIGS. 5A-6C illustrate examples of utilizing an edge-based structure guide (edges are extracted from the frames of the coarse animation prompt 507 and then encoded and provided to the control branch 402). In alternative implementations, the custom animation generation system 102 utilizes a depth map as the structure guidance. For example, the custom animation generation system 102 extracts a depth map from a 3D coarse animation prompt and encodes the depth maps, concatenates the encoded depth maps, and processes the concatenated, encoded depth maps through the control branch 402, which injects control signals into the diffusion model 208 as described above in relation to FIG. 4.

Specifically, In one or more implementations, the custom animation generation system 102 utilizes a depth estimation model to estimate a depth of objects in a digital image frame and stores the determined depth a depth map. For example, the custom animation generation system 102 utilizes a depth estimation neural network as described in U.S. application Ser. No. 17/186,436, filed Feb. 26, 2021, titled “GENERATING DEPTH IMAGES UTILIZING A MACHINE-LEARNING MODEL BUILT FROM MIXED DIGITAL IMAGE SOURCES AND MULTIPLE LOSS FUNCTION SETS,” which is herein incorporated by reference in its entirety. Alternatively, the custom animation generation system 102 utilizes a depth refinement neural network as described in U.S. application Ser. No. 17/658,873, filed Apr. 12, 2022, titled “UTILIZING MACHINE LEARNING MODELS TO GENERATE REFINED DEPTH MAPS WITH SEGMENTATION MASK GUIDANCE,” which is herein incorporated by reference in its entirety.

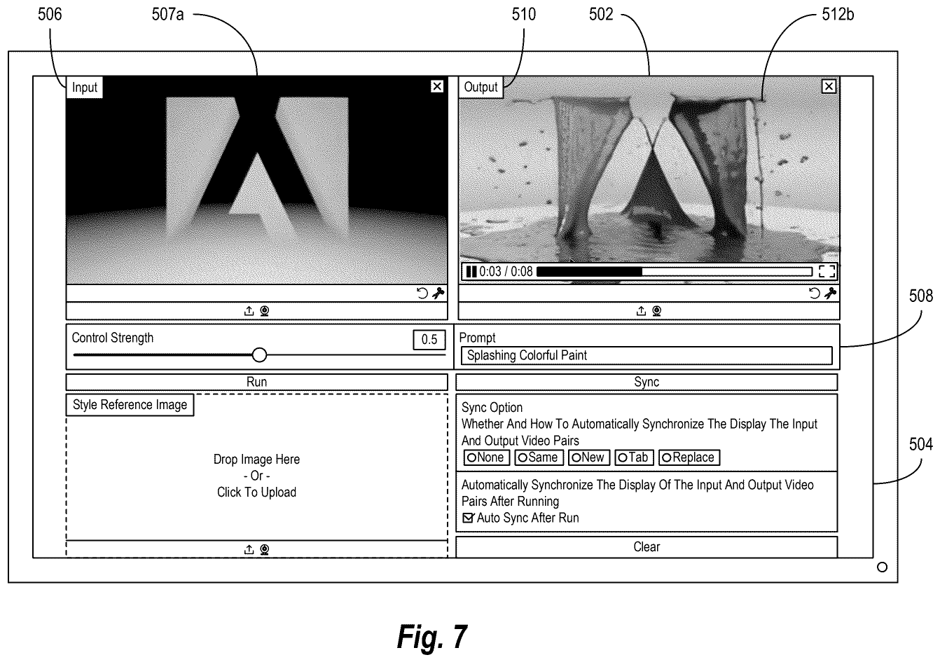

As shown in FIG. 7, the graphical user interface 502 includes an input field 506 for uploading a coarse animation prompt, a text prompt field 508 for entering a text prompt. As shown, in FIG. 7, the user uploads a coarse animation prompt 507a comprising a depth mask corresponding to each frame of the coarse animation prompt 507 via the input field 506. Additionally, as shown in FIG. 7, the user enters a text prompt of “Splashing Colorful Paint” in the text prompt field 508.

As shown in FIG. 7, based on the coarse animation prompt 507a and the text prompt, the custom animation generation system 102 generates a 3D custom animation 512b that includes the structure, timing, and length of the coarse animation prompt 507a and a texture, color, and style as informed by the text prompt. The custom animation generation system 102 displays the custom animation 512b in an output field 510 of the graphical user interface 502. The 3D custom animation 512b that includes the structure (shapes, logos, lines, depth) of the coarse animation prompt 507a and a texture (splashing paint), color (various colors), and style as informed by the text prompt.

In addition to controlling the structure of the custom animation, the custom animation generation system 102 allows for spatial varying control. The custom animation generation system 102 applies spatial varying control via a 2D weight map. During the denoising steps, once the control residual is computed, the 2D weight map is resized and reflated accordingly, and the custom animation generation system 102 multiplies the 2D weight map to the residual tensor (note that the dimension of the residual tensor will be different for different layers). After enhancing the control signal with the spatial varying weight map, the spatial varying is provided to the layers of the diffusion model in the same injection as the structure control operation. In this manner, the custom animation generation system 102 allows a user to identify which regions of a given frame or a given entire coarse animation prompt should be closely followed vs regions of a given frame or a given entire coarse animation prompt that is allowed to be modified during the diffusion process as informed by the text prompt.

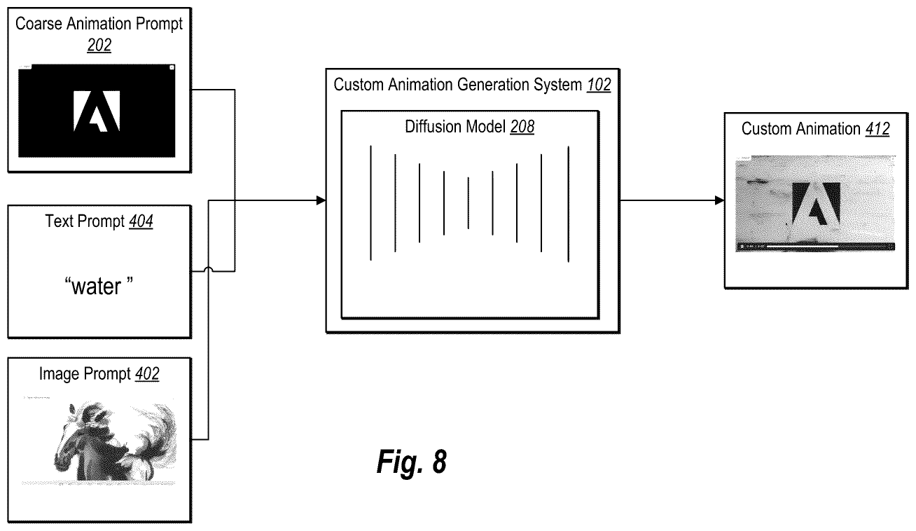

In addition to a text prompt, in one or more implementations, the custom animation generation system 102 allows for the use of an image prompt to further provide guidance to the custom animation generation process. For example, FIG. 8 illustrates that in addition to a text prompt 404 and a coarse animation prompt 202, the custom animation generation system 102 allows for an image prompt 402. The image prompt 402 together with the text prompt informs or conditions the diffusion process of the diffusion model 208 during generation of the custom animation 212.

Specifically, when a style reference image is provided, the custom animation generation system 102 will use the image prompt to control the visual appearance style of the generated animation. The style reference image is encoded into feature space via an image encoder. During each step of diffusion, a cross attention between the style feature and the UNet layer is applied for a pre-defined set of layers. This operation adopts the visual features from the style reference image to the generated animation sequence. Stronger effects are achievable by adding more layers to the pre-defined set of layers for such attention injections. As described above in relation to FIG. 4, the custom animation generation system 102 injects a structural embedding generated from the coarse animation prompt 202 into the diffusion model 208 to control the structure and timing of the custom animation 412.

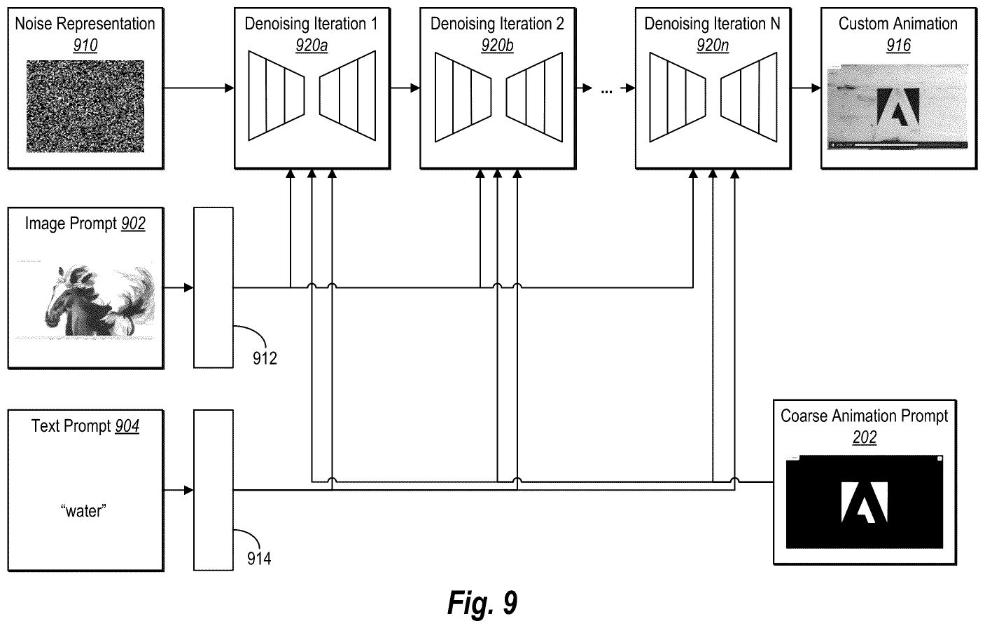

As discussed, in some embodiments, the custom animation generation system 102 generates a custom animation by conditioning denoising iterations of a diffusion neural network. For instance, FIG. 9 illustrates the custom animation generation system 102 utilizing conditioning for a diffusion neural network to generate a custom animation from a noise representation, an image prompt, a text prompt, and a coarse animation prompt in accordance with one or more embodiments.

Specifically, FIG. 9 shows the custom animation generation system 102 obtaining an image prompt 902, text prompt 904, and a coarse animation prompt 202. In some implementations, the custom animation generation system 102 generates vector representations from the prompts. A vector representation includes a numerical representation of features of an image, a text string, or a combination of an image and a text string. For example, an image vector representation includes a feature map, feature vector, or other numerical representation of latent features of a digital image. To illustrate, in some embodiments, the custom animation generation system 102 generates an image vector representation 912 by processing the image prompt 902 through one or more layers of a neural network (e.g., an image encoder). Moreover, a text vector representation includes a feature token, feature vector, or other numerical representation of features of a text string (e.g., features suggesting a semantic connotation or meaning of the text string). To illustrate, in some embodiments, the custom animation generation system 102 generates a text vector representation 914 by processing the text prompt 904 through one or more layers of a neural network (e.g., a text encoder).

Additionally, FIG. 9 shows the custom animation generation system 102 obtaining a noise representation 910. A noise representation includes a noise map or a random distribution of pixels in a digital image. In some implementations, the custom animation generation system 102 utilizes the noise representation 910 to generate a custom animation 916 utilizing a denoising process. For example, the custom animation generation system 102 utilizes a series of denoising iterations 920a-920n (or denoising timesteps) of a diffusion neural network.

Additionally, the custom animation generation system 102 generates a structural embedding from the coarse animation prompt 202. For example, in one or more implementations, the custom animation generation system 102 performs edge detection on each of the frames of the coarse animation prompt 202 to generate a plurality of plurality of edge maps. The custom animation generation system 102 utilizes an encoder to generate a structural embedding from the plurality of edge maps. In another example, the custom animation generation system 102 performs depth estimation on each of the frames of the coarse animation prompt 202 to generate a plurality of plurality of depth maps. The custom animation generation system 102 utilizes an encoder to generate a structural embedding from the plurality of depth maps.

During the diffusion process, the custom animation generation system 102 utilizes a first denoising iteration 920a by processing the noise representation 910 through a diffusion model in the first denoising iteration 920a. In some embodiments, the custom animation generation system 102 conditions layers of the diffusion model in the first denoising iteration 920a with the image vector representation 912, the text vector representation 914, and injects a control signal from a structure control branch based on the coarse animation prompt 202 as discussed above. In some embodiments, the custom animation generation system 102 utilizes the first denoising iteration 920a to generate an additional noise representation from the noise representation 910. For example, the custom animation generation system 102 constructs the additional noise representation from the noise representation 910 utilizing a reverse diffusion process that removes at least some of the random noise contained in the noise representation 910.

In some embodiments, the custom animation generation system 102 repeats the denoising process though successive iterations. For instance, the custom animation generation system 102 utilizes a second denoising iteration 920b to generate a further noise representation from the additional noise representation. For example, the custom animation generation system 102 utilizes a neural network of the second denoising iteration 920b conditioned with the image vector representation 912 and/or the text vector representation 914 to generate the further noise representation.

As the custom animation generation system 102 iteratively repeats this denoising process, in some implementations, the noise representations successively contain less random noise, until the custom animation generation system 102 generates the custom animation 916. For instance, the custom animation generation system 102 utilizes a final denoising iteration 920n to generate the custom animation 916 from a preceding noise representation, the image vector representation 912, the text vector representation 914, and the coarse animation prompt 202. More particularly, in some implementations, the custom animation generation system 102 utilizes a neural network of the final denoising iteration 920n to generate the custom animation 916, similarly to the description above of utilizing the neural networks of the preceding denoising iterations.

In some embodiments, the custom animation generation system 102 determines a number of denoising iterations of the diffusion neural network to condition utilizing the image vector representation 912, the text vector representation 914, and/or the structural embedding from the coarse animation prompt 202. To illustrate, in some implementations, the custom animation generation system 102 determines that the image vector representation 912 contains important color information that should influence the custom animation 916. In some cases, the diffusion neural network captures color information in the first few denoising iterations. Thus, in some implementations, the custom animation generation system 102 determines a number of initial denoising iterations to condition utilizing the image vector representation 912. For example, the custom animation generation system 102 processes the image vector representation 912 through these initial denoising iterations and omits the image vector representation 912 from at least some of the remaining denoising iterations.

Specifically, by conditioning the diffusion models based on style of image and text prompts, the custom animation generation system 102 generates custom animations that more accurately reflect a design intent (e.g., style) underlying the image and text prompts. To illustrate, by conditioning layers of the diffusion models that attend more to style-specific tokens with style-specific prompt information, the custom animation generation system 102 increases the style-wise accuracy of the generated custom animation. Similarly, by conditioning layers of the neural network that attend more to content-specific tokens with content-specific prompt information, the custom animation generation system 102 increases the style-wise accuracy of the generated custom animation.

Along related lines, by conditioning the diffusion models based on a structure and timing of a coarse animation prompt 202, the custom animation generation system 102 generates custom animations that more accurately reflect a design intent (e.g., timing, length, structure) from the coarse animation prompt 202. To illustrate, by conditioning layers of the diffusion models that attend more to structure-specific tokens with structure-specific prompt information, the custom animation generation system 102 increases the structure-wise accuracy of the generated custom animation. Similarly, by conditioning layers of the neural network that attend more to content-specific tokens with timing-specific prompt information, the custom animation generation system 102 increases the timing-wise accuracy of the generated custom animation.

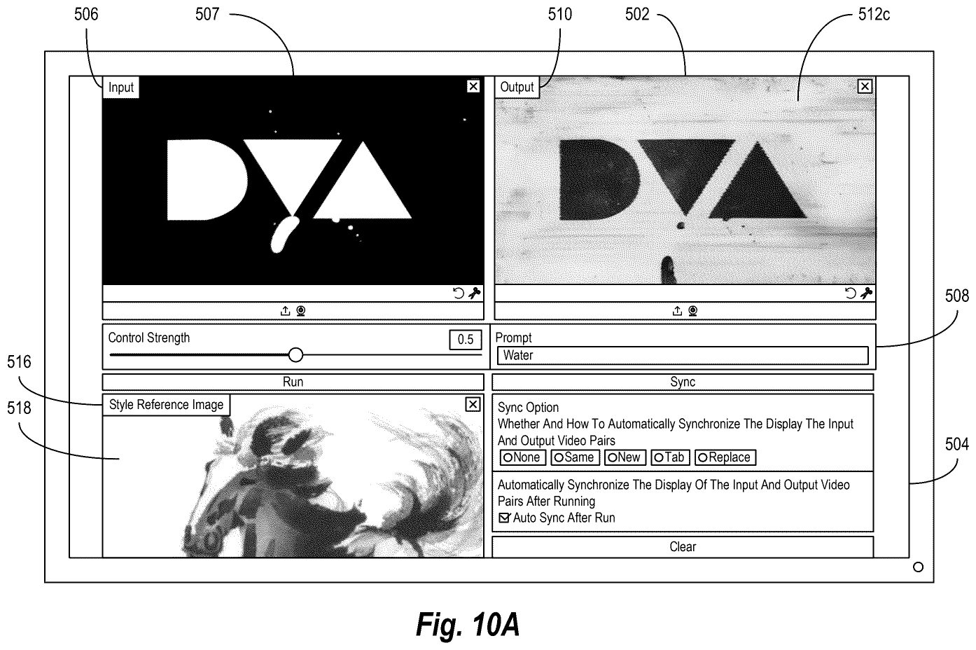

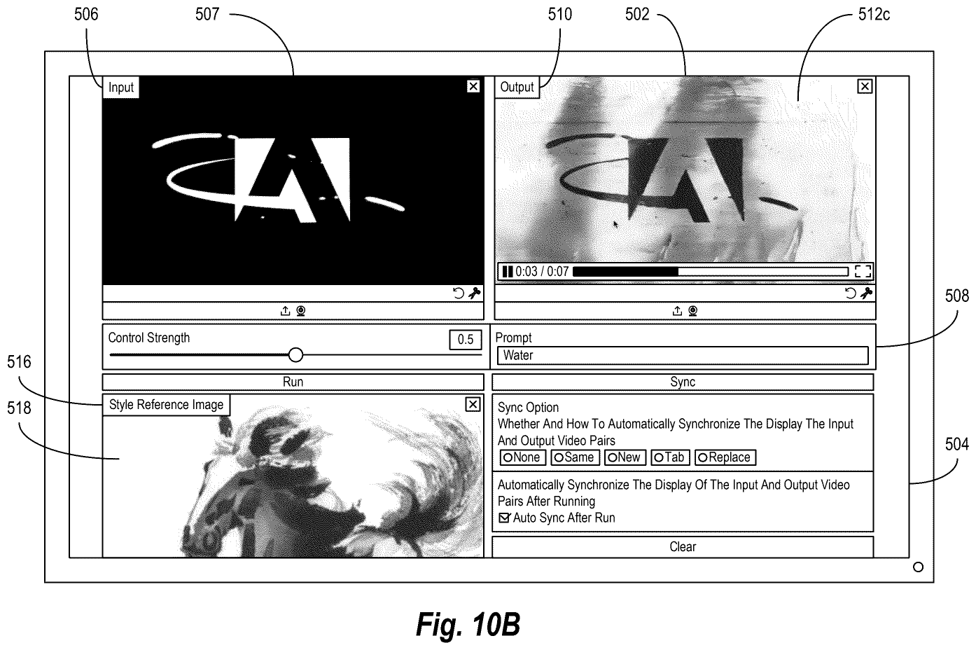

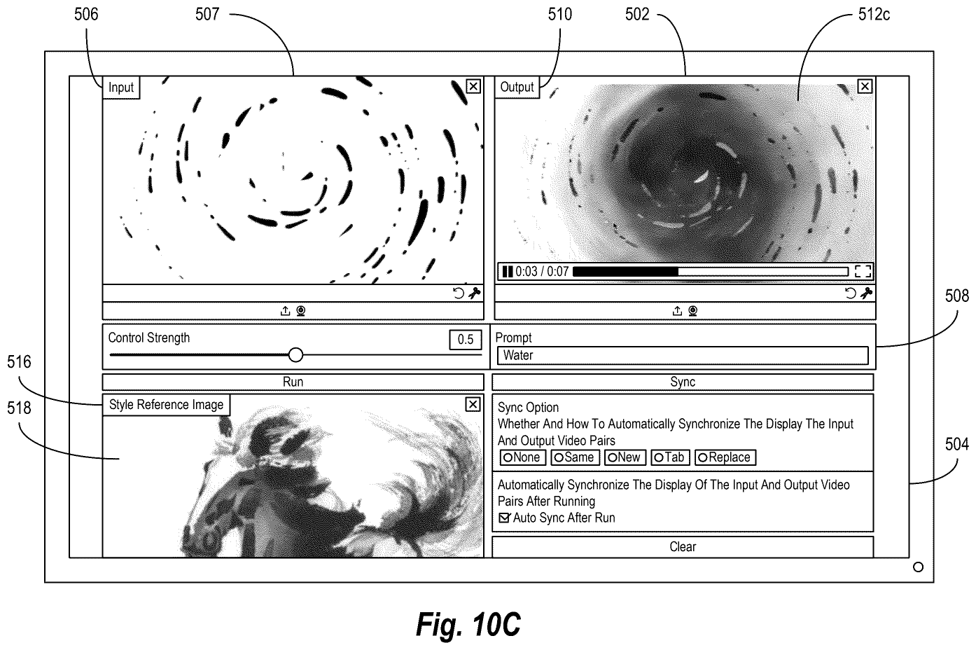

FIGS. 10A-10C illustrate a graphical user interface 502 provided by the custom animation generation system 102 with which a user interacts to generate a custom animation. As shown, the graphical user interface 502 includes the input field 506 for uploading a coarse animation prompt 507, a text prompt field 508 for entering a text prompt, and an image input field 516 for uploading an image prompt 518 (e.g., a style reference image). Based on the coarse animation prompt 507, the image prompt 518, and the text prompt, the custom animation generation system 102 generates a custom animation 512c that includes the structure, timing, and length of the coarse animation prompt 507 and a texture, color, and style as informed by the text prompt and the image prompt 518.

As shown in FIGS. 10A-10C, the custom animation generation system 102 generates the custom animation 512c generated to include the structure, timing, and length of the coarse animation prompt 507 and a texture, color, and style as informed by the text prompt and the image prompt. The custom animation generation system 102 displays the custom animation 512c in an output field 510 of the graphical user interface 502. Furthermore, as shown in FIGS. 10A-10C, the custom animation 512c has finer details than the coarse animation prompt 507, including warping, lighting effects, texture, color, and other stylistic effects. Specifically, 10A-10C show different frames of both the coarse animation prompt 507 and the custom animation 512c. The comparison of which show that the custom animation generation system 102 generates the custom animation 512c that includes the structure (shapes, logos, lines) of the coarse animation prompt 507 and a texture (water), color, and style as informed by the text prompt and the image prompt. Indeed, as shown, the custom animation 512c has finer details than the coarse animation prompt 507, including warping, lighting effects, texture, color, and other stylistic effects.

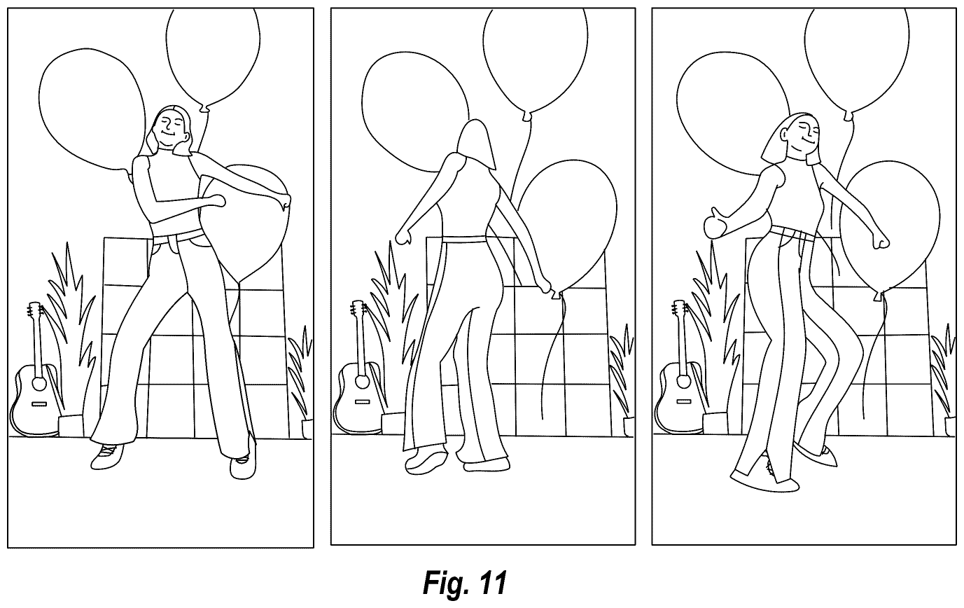

The custom animation generation system 102 allows for generating custom animations in layers that a user is able to add to a video. Thus, rather than generating a custom animation alone, the custom animation generation system 102 is able to generate and add a custom animation to a digital video. For example, FIG. 11 illustrates frames from a video into which the custom animation generation system 102 has added a custom animation. Specifically, the custom animation generation system 102 adds frames of the custom animation as a layer between a foreground (girl dancing) and a background (room and bookshelf).

In one or more embodiments, the custom animation generation system 102 utilizes a diffusion transformer model instead of a U-Net based diffusion model. Specifically, a diffusion transformer model refers to a model architecture that leverages principles of diffusion models with a transformer architecture. For example, the diffusion transformer model includes deep learning self-attention mechanisms that process sequential data. For instance, the diffusion transformer model establishes relationships between elements in a sequence using self-attention mechanisms. To illustrate, the custom animation generation system 102 utilizes the diffusion transformer model to denoise noised representations (e.g., noised tokens) at a transformer block and to reconstruct data and generate media (e.g., animations, video, images, text, etc.).

As mentioned above, the custom animation generation system 102 utilizes a diffusion transformer model in one or more embodiments. For example, in one or more implementations, the custom animation generation system 102 utilizes a single stream transformer. As mentioned above, the custom animation generation system 102 utilizes the diffusion transformer model which refers to a model architecture that leverages principles of diffusion models with a transformer architecture. Specifically, a single stream transformer refers to a diffusion transformer that does not have conditioning inputs (e.g., modulation inputs and/or modulation layers, such as adaLN modulation) to denoise noised tokens. For instance, the single stream transformer encompasses a single stream of input data going in and generating output data from the input data. To illustrate, the single stream transformer includes one or more transformer blocks where each transformer block includes a self-attention layer and a multi-layer perceptron. In other words, the custom animation generation system 102 utilizes the single stream transformer that does not include a cross-attention layer (e.g., this is in opposition to single stream) nor does it include modulation layers. In other words, in some embodiments, the custom animation generation system 102 utilizes a single stream transformer that only consists of a self-attention layer and a multi-layer perceptron.

The custom animation generation system 102 utilizes the diffusion transformer model to generate denoised tokens. In one or more embodiments, the custom animation generation system 102 generates the denoised tokens from the noised tokens using a single stream transformer (e.g., the diffusion transformer model 210). Specifically, the denoised tokens refers to a clean version of data with noise added to data removed according to the tokens and positional encodings. For instance, over a number of denoising timesteps (e.g., transformer blocks), the custom animation generation system 102 utilizes the diffusion transformer model to remove the noise from the noised tokens according to various guides (e.g., the tokens, a coarse animation prompt, position encodings which are described in more details below, and token-level timestep embeddings, which are also described in more detail below).

The custom animation generation system 102 utilizes a decoder to generate custom animations. In one or more embodiments, the custom animation generation system 102 processes denoised tokens with the decoder to generate the custom animations. Specifically, the custom animation generation system 102 generates a video from denoised tokens. For instance, in some embodiments, the custom animation generation system 102 utilizes the decoder that includes one or more layers (e.g., linear transformation, self-attention layer, SoftMax layer, etc.) to transform the denoised tokens into the custom animations. In some embodiments, the custom animation generation system 102 utilizes one or more decoders of a dual-variational autoencoder model.

In one or more embodiments, a token refers to a discrete unit of representation for an input (e.g., a text prompt input and/or a visual prompt input) that a transformer-based model processes. For instance, the custom animation generation system 102 breaks up a frame of a sequence of frames into a sequence of tokens where each token in the sequence of tokens represents different image patch. In one or more embodiments, the encoder further transforms the text/visual prompts into a latent space as part of generating the tokens.

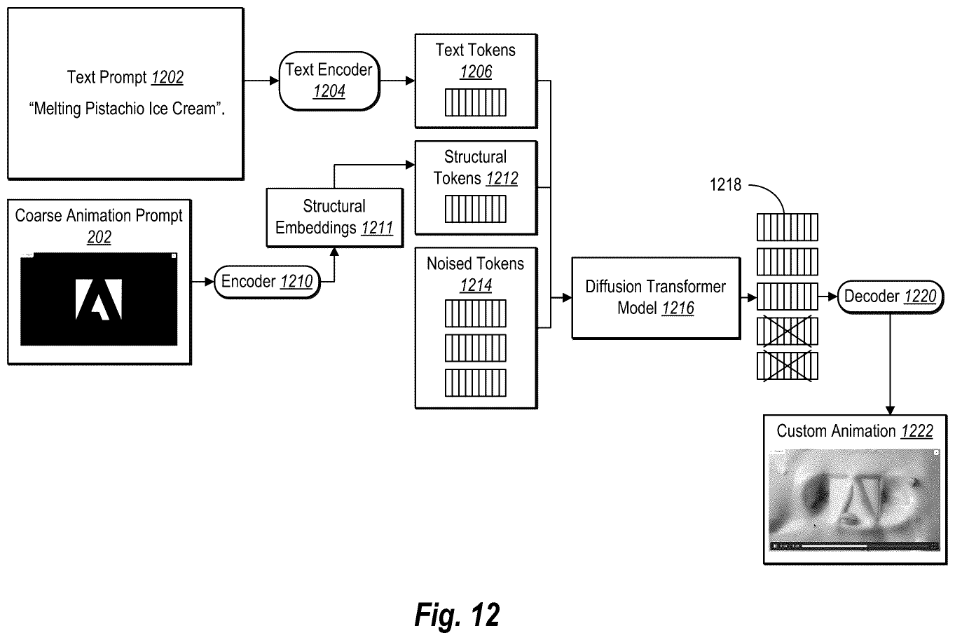

As mentioned above, in some embodiments, the custom animation generation system 102 receives a coarse animation prompt 202. FIG. 12 illustrates the custom animation generation system 102 using a diffusion model to generate a custom animation from a text prompt and a coarse animation prompt 202 in accordance with one or more embodiments.

FIG. 12 shows the custom animation generation system 102 receiving a text prompt 1202. Specifically, the text prompt 1202 reads “melting pistachio ice cream.” FIG. 12 shows the custom animation generation system 102 utilizes a text encoder 1204 to process the text prompt 1202 and generate text tokens 1206.

Further, FIG. 12 shows the custom animation generation system 102 receiving a coarse animation prompt 202. In one or more embodiments, the coarse animation prompt 202 refers to a visual input to guide the custom animation generation system 102 to generate custom animations 1222. For example, the coarse animation prompt 202 includes a coarse video that has a resolution lower than a resolution of the custom animation 1222 generated therefrom.

In one or more embodiments, the custom animation generation system 102 utilizes an image encoder to process the coarse animation prompt 202. In one or more embodiments, an image encoder is a neural network (or one or more layers of a neural network) that extract features relating to digital images/video frames. In some cases, an image encoder refers to a neural network that both extracts and encodes features from a digital image. For example, an image encoder includes a particular number of layers including one or more fully connected and/or partially connected layers of neurons that extract image patches from the digital image and encode localized features of the digital image. To illustrate, in one or more embodiments, the custom animation generation system 102 generates an image embedding that represents a complete frame of the coarse animation prompt 202. As shown in FIG. 12, the custom animation generation system 102 utilizes an encoder 1210 to encode the coarse animation prompt 202.

FIG. 12 shows the custom animation generation system 102 generating structural embeddings 1211 from the coarse animation prompt 202 using the encoder 1210. In one or more embodiments, the custom animation generation system 102 utilizes the encoder to generate structural embeddings 1211 from edge maps or depth maps generated from the frames of the coarse animation prompt 202. In some embodiments, the structural embeddings 1211 include a numerical representation (e.g., a vector) of a frame of the coarse animation prompt 202. For instance, the image embeddings capture features and properties of the frame. To illustrate, the structural embeddings 1211 include structural information such as the outline of objects, shapes, and spatial relationships.

Further, FIG. 12 shows the custom animation generation system 102 generating structural tokens 1212 from the structural embeddings 1211. Specifically, the custom animation generation system 102 utilizes a tokenization model (e.g., patchification) to generate the structural tokens 1212 from the structural embeddings 1211.

As shown in FIG. 12, the custom animation generation system 102 processes the text tokens 1206, the structural tokens 1212, and noised tokens 1214 with a diffusion transformer model 1216. For instance, the custom animation generation system 102 combines the text tokens 1206, the structural tokens 1212, and the noised tokens 1214 to generate combined tokens. Specifically, the custom animation generation system 102 via the diffusion transformer model 1216 utilizes the structural tokens 1212 and the text tokens 1206 as a guide to remove noise from the noised tokens 1214. FIG. 12 shows the custom animation generation system 102 utilizes the diffusion transformer model 1216 to generate denoised tokens 1218. Furthermore, FIG. 12 shows the custom animation generation system 102 discarding the text tokens 1206 and the structural tokens 1212 after removing noise from the denoised tokens 1218. Additionally, FIG. 12 shows the custom animation generation system 102 processing the denoised tokens 1218 with a decoder 1220 to generate a custom animation 1222.

Although FIG. 12 shows the custom animation generation system 102 processing both the text prompt 1202 and the coarse animation prompt 202, in one or more embodiments, the custom animation generation system 102 only receives the coarse animation prompt 202. Specifically, the custom animation generation system 102 utilizes the diffusion transformer model 1216 to process the noised tokens 1214 and the structural tokens 1212 to remove noise from the noised tokens 1214 according to the structural tokens 1212 and generate the custom animation 1222.

As noted above, the custom animation generation system 102 allows a user to select spatial and/or temporal locations to which greater or lesser weight is given to the structural conditioning. In this manner, the custom animation generation system allows a user to specify spatial and/or time locations (e.g., an indication of a subset of frames) that should strongly correspond to the coarse animation prompt, while allowing the system more creativity in other parts of the custom animation. For example, a user may desire a logo to have strong correspondence to the coarse animation prompt but want to give the custom animation generation system more creative abilities in other areas of the custom animation such as the background.

To enable this functionality, in one or more implementations, instead of controlling the strength of the guidance from the control branch 402 by a single value, the custom animation generation system 102 applies spatial and/or temporal varying control via a 2D weight map. During the denoising steps, once the custom animation generation system 102 generates the control residual, the custom animation generation system 102 resizes the 2D weight map accordingly and multiplies the 2D weight map to the residual tensor (note that the dimension of the residual tensor will be different for different layers). After enhancing the control signal with the spatial varying weight map, the injection will be the same as the spatial control operation.

Specifically, in or more embodiments, the custom animation generation system 102 utilizes spatial-temporal positional encodings as a 2D weight map to control locations (within a coarse animation prompt) and/or times are given more weight during the diffusion process.

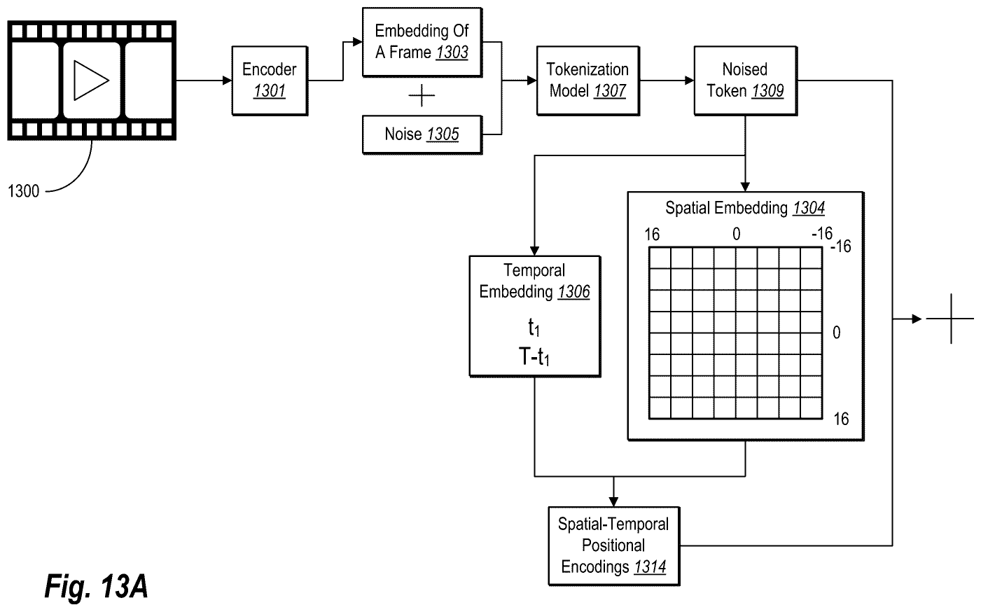

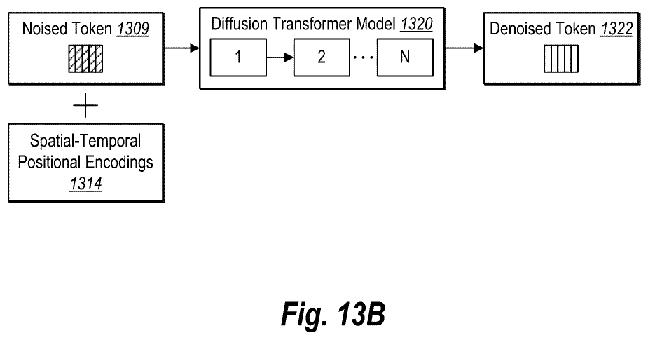

FIG. 13A illustrates an example diagram of the custom animation generation system 102 generating noised tokens and spatial-temporal positional encodings. As shown, the custom animation generation system 102 utilizes an encoder 1301 to process the coarse animation prompt 1300 and generate an embedding 1303 of a frame. Similar to the discussion above in FIG. 7, in one or more embodiments, the custom animation generation system 102 adds noise 1305 to the embedding 1303 of a frame and further utilizes a tokenization model 1307 to generate a noised token 1309.

In one or more embodiments, the custom animation generation system 102 generates a sequence of noised tokens from the coarse animation prompt 1300. Specifically, the custom animation generation system 102 generates a series of noised tokens representing various elements of the coarse animation prompt 1300. For instance, the series of noised tokens represents image frames, keyframes, motion frames and additional features within each frame. To illustrate, the custom animation generation system 102 utilizes the dual-variational autoencoder model to generate embeddings of the coarse animation prompt 1300 (e.g., generates image embeddings and keyframe embeddings utilizing the 2DVAE and generates motion embeddings utilizing the 3DVAE).

Moreover, the custom animation generation system 102 utilizes a tokenization model (patchification) to generate the noised token 1309 of the embedding 1303 of a frame. To illustrate, the custom animation generation system 102 utilizes the tokenization model to transform each frame's feature vector into multiple noised tokens (e.g., corresponding to image patches of a frame), and further generates noised tokens (that indicate the motion frames) that are based on temporal features of the sequence of frames.

FIG. 13A shows the custom animation generation system 102 utilizing a centered two-dimensional coordinate map to generate a spatial embedding 1304 for the noised token 1309. In one or more embodiments, the spatial embedding 1304 refers to a representation of spatial relationships and positions of visual elements within a frame (e.g., an image) of a sequence of frames. Specifically, the spatial embedding 1304 includes an indication of where objects/elements in a frame are located, the orientation of objects/elements, the size of objects/elements, and their spatial relationship with different regions of the frame that they are located within. For instance, the custom animation generation system 102 utilizes coordinate information (e.g., x-dimension and y-dimension, and in some embodiments a z-dimension) for objects/elements within a frame. In some embodiments, the spatial embedding 1304 indicates absolute position within a frame and in some embodiments, the spatial embedding 1304 indicates relative position (e.g., relative to other objects/elements within a frame).

In one or more embodiments, the custom animation generation system 102 utilizes a centered two-dimensional coordinate map to generate the spatial embedding 1304 of the noised token 1309 (e.g., of a sequence of noised tokens). For example, the noised token 1309 represents a single image patch in a frame of a sequence of frames, a subset of noised tokens represents an entire frame within a sequence of frames, and the sequence of noised tokens represents the entire sequence of frames.

For instance, the custom animation generation system 102 utilizes a first positional encoding function (e.g., a sine or cosine function) for a first frame of the video to capture a first dimension (x position) of the image patch corresponding to the noised token 1309 within a frame. Further, the custom animation generation system 102 utilizes a second positional encoding function to capture a second dimension (y position) of the image patch corresponding to the noised token 1309 within the frame. Moreover, the custom animation generation system 102 labels the noised token 1309 (e.g., assigns the image patch corresponding to the token) to a space on the centered two-dimensional coordinate map based on the first dimension (x-dimension) and the second dimension (e.g., the y-dimension) of the token to generate the spatial embedding 1304 for the token. As mentioned above, due to the centered nature of the coordinate map, the custom animation generation system 102 preserves/incorporates video attributes such as the aspect ratio of the video.

In other words, the custom animation generation system 102 generates the spatial embeddings 1304 to index the locations of image patches within a frame. Further, the custom animation generation system 102 generates additional spatial embeddings for additional noised tokens within additional frames. Accordingly, the custom animation generation system 102 generates a plurality of spatial embeddings to index image patches relative to other image patches within the same frame and further indexes additional image patches relative to other additional image patches within additional frames.

As further shown, the custom animation generation system 102 generates a temporal embedding 1306. In one or more embodiments, the temporal embedding 1306 refers to a representation of a frame within a sequence of visual frames. Specifically, the custom animation generation system 102 utilizes the temporal embedding 1306 to capture motion information, action sequences, and transitions between frames within a sequence of frames. In other words, the custom animation generation system 102 generates the temporal embedding 1306 to create a representation of sequential dependencies between frames of a sequence of frames.

In one or more embodiments, the custom animation generation system 102 generates the temporal embedding 1306 based on a timestamp and an inverse timestamp. For example, the custom animation generation system 102 determines a timestamp for the noised token 1309 (e.g., for a first frame of a sequence of frames of the video). Specifically, a timestamp of a first frame refers to a specific point in time at which a frame of the noised token 1309 appears within the overall video or the sequence of frames, relative to the start of the video. Furthermore, the custom animation generation system 102 determines an inverse timestamp, which refers to a difference in a total length of the video and the temporal position (e.g., current position) of the frame of the noised token 1309 relative to the sequence of frames. Moreover, the custom animation generation system 102 combines the timestamp and the inverse timestamp of the noised token 1309 to generate the temporal embedding 1306.

As further shown in FIG. 13A, the custom animation generation system 102 combines the spatial embedding 1304 and the temporal embedding 1306 to generate spatial-temporal positional encodings 1314. In one or more embodiments, the spatial-temporal positional encodings 1314 refer to a data representation of information relating to both spatial relationships and positions of visual elements within a frame and motion information, action sequences, and transitions between frames within a sequence of frames (e.g., sequential dependencies between frames). Specifically, the spatial-temporal positional encodings 1314 includes a combined data representation that captures information from the visual dimension and the temporal dimension. Accordingly, the custom animation generation system 102 utilizes the spatial-temporal positional encodings 1314 to remove noise from noised tokens in a high-quality and accurate manner (e.g., to incorporate the context indicated by the data in the spatial-temporal positional encodings 1314).

Further, as shown in FIG. 13A, the custom animation generation system 102 combines/adds the noised token 1309 with the spatial-temporal positional encodings 1314 (e.g., to generate a combined noised token with spatial temporal positional encodings). Thus, the custom animation generation system 102 processes the noised token 1309 and the spatial-temporal positional encodings 1314 using a diffusion transformer model to remove noise from the noised token 1309 according to the spatial-temporal positional encodings 1314.

Once the spatial-temporal positional encodings 1314 are generated the custom animation generation system 102 provides a weight to different special locations (different patches) to cause the diffusion processes to give more weight to the structure from the coarse animation prompt 1300. For example, a user can select which areas of a frame of the coarse animation prompt they what to give more structural weight to during generation of the custom animation. The custom animation generation system 102 then applies a weight (e.g., a multiplier) to the corresponding areas of the spatial-temporal positional encodings 1314 to ensure that more weight is given to the structure of the coarse animation prompt 1300 at those locations/times.

FIG. 13B illustrates the custom animation generation system 102 processing noised tokens and spatial-temporal positional encodings to modify parameters of a diffusion transformer model. Specifically, FIG. 13B shows the custom animation generation system 102 processing the noised token 1309 and the spatial-temporal positional encodings 1314 (e.g., the custom animation generation system 102 combines the noised token 1309 with the spatial-temporal positional encodings 1314 to create a combined token) and uses the diffusion transformer model 1320 to remove noise from the noised token 1309 to generate denoised token 1322.

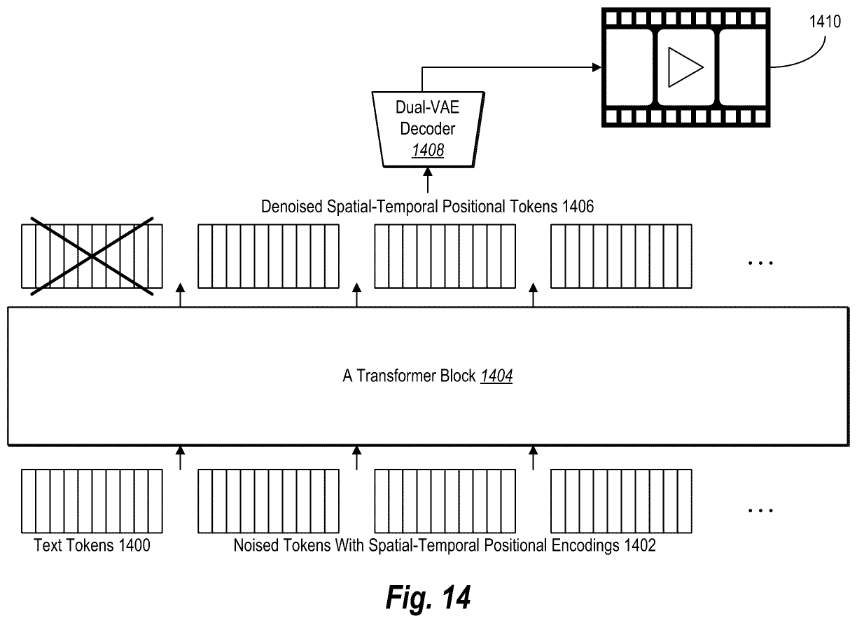

FIG. 14 illustrates the custom animation generation system 102 at inference time processing the noised tokens and the spatial-temporal positional encodings with a transformer block (e.g., in response to a video generation request to generate a video from a text prompt). For example, FIG. 14 shows text tokens 1400 and noised tokens with spatial-temporal positional tokens 1402. Specifically, as further shown, the custom animation generation system 102 utilizes a transformer block 1404 to remove noise from the noised tokens according to the spatial-temporal positional tokens and the text tokens 1400. Furthermore, FIG. 14 shows the custom animation generation system 102 utilizing the transformer block 1404 to generate denoised spatial-temporal positional tokens while also discarding the text tokens 1400.

In one or more embodiments, the custom animation generation system 102 discards the text tokens 1400 because the text tokens 1400 are useful for denoising the noised tokens but are not necessary for generating the media (e.g., the image or the video). As shown in FIG. 14, the custom animation generation system 102 utilizes a dual-VAE decoder 1408 to process the denoised spatial-temporal positional tokens 1406 to generate a custom animation 1410. To illustrate, the custom animation generation system 102 generates media that includes a video in accordance with video attributes indicated by the spatial-temporal positional encodings, a text prompt, and/or a coarse animation prompt.

The custom animation generation system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the custom animation generation system 102 may be implemented as a stand-alone application, such as a desktop or mobile application. Furthermore, the components of the custom animation generation system 102 may be implemented as one or more web-based applications hosted on a remote server. Alternatively, or additionally, the components of the custom animation generation system 102 may be implemented in a suite of mobile device applications or “apps.” For example, in one or more embodiments, the custom animation generation system 102 can comprise or operate in connection with digital software applications such as ADOBE® FIREFLY, ADOBE® CREATIVE CLOUD, ADOBE® PHOTOSHOP®, ADOBE® PREMIERE PRO, ADOBE® AFTER EFFECTS, AND ADOBE® ILLUSTRATOR.

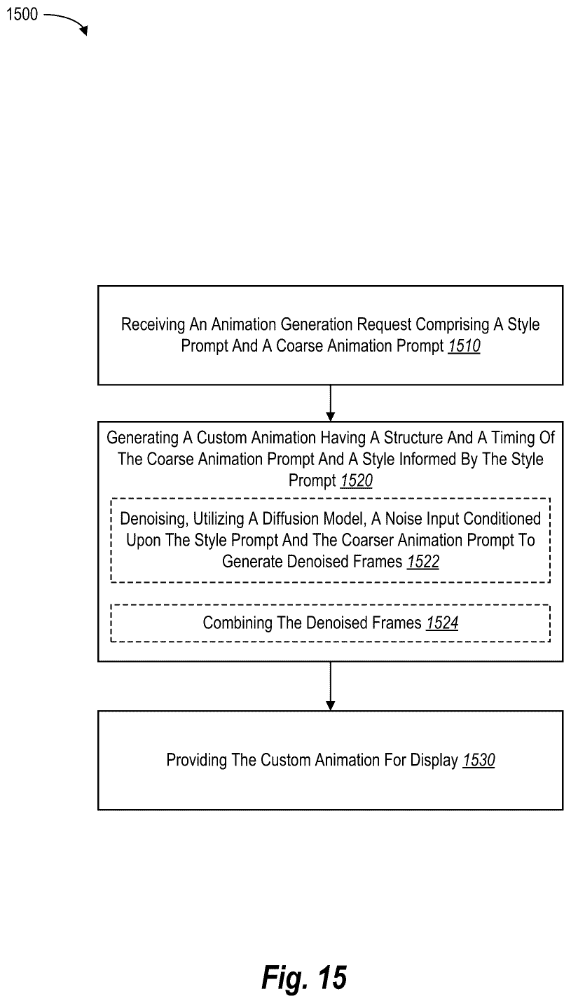

FIGS. 1-14, the corresponding text, and the examples provide a number of different methods, systems, devices, and non-transitory computer-readable media of the custom animation generation system 102. In addition to the foregoing, one or more embodiments can also be described in terms of flowcharts comprising acts for accomplishing the particular result, as shown in FIG. 15. Further, the acts may be performed in different orders. Additionally, the acts described herein may be repeated or performed in parallel with one another or in parallel with different instances of the same or similar acts.

FIG. 15 illustrates a flowchart of a series of acts 1500 for generating a custom animation in accordance with one or more embodiments. FIG. 15 illustrates acts according to one embodiment, alternative embodiments may omit, add to, reorder, and/or modify any of the acts shown in FIG. 15. In some implementations, the acts of FIG. 15 are performed as part of a method. For example, in one or more embodiments, the acts of FIG. 15 are performed as part of a computer-implemented method. Alternatively, a non-transitory computer-readable medium can store instructions thereon that, when executed by at least one processor, cause a computing device to perform the acts of FIG. 15. In one or more embodiments, a system performs the acts of FIG. 15. For example, in one or more embodiments, a system includes at least one memory device. The system further includes at least one server device configured to cause the system to perform the acts of FIG. 15.

The series of acts 1500 includes an act 1510 of receiving an animation generation request comprising a style prompt and a coarse animation prompt. Further, the series of acts 1500 includes an act 1520 of generating a custom animation having a structure and a timing of the coarse animation prompt and a style informed by the style prompt. Moreover, in one or more implementations, the act 1520 includes an act 1522 of denoising, utilizing the diffusion model, a noise input conditioned upon the style prompt and the coarse animation prompt. Further, in one or more implementations, the act 1520 includes an act 1524 of combining the denoised frames. The series of acts 1500 also includes an act of 1530 of providing the custom animation for display via a graphical user interface. For example, act 1530 can involve providing the custom animation to a client device that will display the custom animation via a graphical user interface or providing the custom animation to a graphics processing unit that displays the custom animation via a graphical user interface.

Further, in one or more embodiments, the series of acts 1500 includes generating a plurality of edge maps from frames of the coarse animation prompt. In such embodiments, the series of acts 1500 includes generating a structural embedding from the plurality of edge maps. Additionally, the act of denoising, utilizing the diffusion model, the noise input conditioned upon the style prompt and the coarse animation prompt comprises injecting the structural embedding into layers of the diffusion model utilizing a structure control branch. In such embodiments, generating the custom animation comprises generating a two-dimensional custom animation.

Additionally, in one or more embodiments, the series of acts 1500 includes generating a plurality of depth maps from frames of the coarse animation prompt. In such embodiments, the series of acts 1500 includes generating a structural embedding from the plurality of depth maps. Additionally, the act of denoising, utilizing the diffusion model, the noise input conditioned upon the style prompt and the coarse animation prompt comprises injecting the structural embedding into layers of the diffusion model utilizing a structure control branch. In such embodiments, generating the custom animation comprises generating a three-dimensional custom animation.

In one or more embodiments, the act 1510 includes receiving a style prompt and a coarse animation prompt. For example, act 1510, in one or more embodiments, comprises receiving a text prompt. In such implementations, act 1522 of denoising, utilizing the diffusion model, the noise input conditioned upon the style prompt comprises generating the denoised frames to have a style informed by the text prompt.

In one or more embodiments, act 1510 comprises receiving the coarse animation prompt as a black and white animation video. In such implementations, act 1520 of generating the custom animation comprises generating the custom animation to have a resolution higher than a resolution of the coarse animation prompt.

In one or more embodiments, act 1510 comprises receiving a stylized image and a text prompt as the style prompt. In such implementations, act 1522 of denoising, utilizing the diffusion model, the noise input conditioned upon the style prompt comprises generating the denoised frames to have a style informed by the stylized image and the text prompt.

Additionally, in one or more embodiments, the series of acts 1500 includes receiving, via a graphical user interface, an indication of a structure control strength. In such implementations, the act 1520 of generating, utilizing the diffusion model, the custom animation having the structure and the timing of the coarse animation prompt and the style informed by the style prompt comprises giving more weight to one of the structure of the coarse animation prompt or the style prompt based on the indication of the structure control strength.

Additionally, in one or more embodiments, the series of acts 1500 includes receiving, via a graphical user interface, an indication of a spatial location within the coarse animation prompt. In such implementations, the act 1520 of generating, utilizing the diffusion model, the custom animation having the structure and the timing of the coarse animation prompt and the style informed by the style prompt comprises giving more weight the structure of the coarse animation prompt than the style prompt in the spatial location.

In one or more implementations, act 1510 of receiving an animation generation request comprising receiving a text prompt, an image prompt, and a coarse animation prompt via a graphical user interface. For example, act 1510 involves, in one or more implementations, receiving a two-dimensional video as the coarse animation prompt. Additionally, in one or more implementations, act 1522 comprises denoising, utilizing the diffusion model, a noise input conditioned upon the text prompt, the image prompt, and the coarse animation prompt to generate denoised frames having a structure of the coarse animation prompt and a style informed by the text prompt and the image prompt. Furthermore, act 1524 comprises, in one or more implementations, combining the denoised frames to generate a custom animation having the timing of the coarse animation prompt.

Also, in one or more implementations, the series of acts 1500 comprises generating, utilizing a depth estimation model, a plurality of depth maps from frames of the coarse animation prompt. The series of acts 1500 also involves generating, utilizing an encoder, a structural embedding from the plurality of depth maps. In such implementations, act 1522 involves denoising, utilizing the diffusion model, the noise input conditioned upon the style prompt and the coarse animation prompt comprises injecting the structural embedding into layers of the diffusion model utilizing a structure control branch.

In one or more implementations, the series of acts 1500 comprises receiving an indication of a spatial location within the coarse animation prompt. In such implementations, act 1522 involves denoising, utilizing the diffusion model, the noise input conditioned upon the text prompt, the image prompt, and the coarse animation prompt to generate denoised frames having the structure of the coarse animation prompt and the style informed by the text prompt and the image prompt comprising giving more weight to the structure of the coarse animation prompt in the spatial location during denoising and giving more weight to the style informed by the text prompt and the image prompt in locations other than the spatial location.

In one or more implementations, the series of acts 1500 comprises receiving an indication a subset of frames within the coarse animation prompt. In such implementations, act 1522 involves denoising, utilizing the diffusion model, the noise input conditioned upon the text prompt, the image prompt, and the coarse animation prompt to generate denoised frames having the structure of the coarse animation prompt and the style informed by the text prompt and the image prompt comprising giving more weight to the structure of the coarse animation prompt for subset of frames during denoising and giving more weight to the style informed by the text prompt and the image prompt for frames other than the subset of frames.

In one or more implementations, act 1510 of receiving an animation generation request comprising receiving a coarse animation prompt comprising a plurality of frames forming a video. In such implementations, the series of acts 1500 further involves extracting, utilizing a depth estimation model, depth maps from the plurality of frames of the coarse animation prompt. The series of acts 1500 also involves generating, utilizing an encoder, one or more structural embeddings from the depth maps. In such implementations, act 1520 comprises denoising, utilizing the diffusion model, a noise input and during denoising, utilizing a structure control branch, injecting the one or more structural embeddings into layers of the diffusion model.

Additionally, act 1520 involves generating the custom animation to have a style of the style prompt by conditioning the denoising upon the style prompt, where the style prompt comprises a text prompt and an image prompt. In one or more implementations, act 1520 involves generating, utilizing the diffusion model, the custom animation having the structure of the coarse animation prompt by utilizing a diffusion transformer model to generate the custom animation to have a length of the video of the coarse animation prompt and a resolution greater than a resolution of the animation prompt.

### Architecture: Pixel Diffusion

In particular, FIG. 16 shows an example of a guided diffusion model 1600 according to aspects of the present disclosure. In some examples, guided diffusion model 1600 describes an example operation and architecture of a diffusion model 208 described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, the guided diffusion model 1600 may take an original media item 1605 in a pixel space 1610 as input and apply forward diffusion process 1615 to gradually add noise to the original media item 1605 to obtain noisy media item 1620 at various noise levels.

Next, a reverse diffusion process 1625 (e.g., a U-Net) gradually removes the noise from the noisy media item 1620 at the various noise levels to obtain an output media item 1630. In some cases, an output media item 1630 is created from each of the various noise levels. The output media item 1630 can be compared to the original media item 1605 to train the reverse diffusion process 1625.

The reverse diffusion process 1625 can also be guided based on a text prompt 1635, or another guidance prompt, such as a custom animation generation prompt, a reference image, a layout, a segmentation map, etc. The text prompt 1635 can be encoded using a text encoder 1640 (e.g., a multimodal encoder) to obtain guidance features 1645 in guidance space 1650. The guidance features 1645 can be combined with the noisy media item 1620 at one or more layers of the reverse diffusion process 1625 to ensure that the output media item 1630 includes content described by the text prompt 1635. For example, guidance features 1645 can be combined with the noisy features using a cross-attention block within the reverse diffusion process 1625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

FIG. 17 shows an example of a U-Net 1700 according to aspects of the present disclosure. In some examples, U-Net 1700 is an example of the component that performs the reverse diffusion process 1625 of guided diffusion model 1600 described with reference to FIG. 16 and includes architectural elements of the diffusion model 208 described herein. The U-Net 1700 depicted in FIG. 17 is an example of, or includes aspects of, the architecture used within the reverse diffusion process described with reference to FIG. 16.

In some examples, diffusion models are based on a neural network architecture known as a U-Net. The U-Net 1700 takes input features 1705 having an initial resolution and an initial number of channels and processes the input features 1705 using an initial neural network layer 1710 (e.g., a convolutional network layer) to produce intermediate features 1715. The intermediate features 1715 are then down-sampled using a down-sampling layer 1720 such that the down-sampled features 1725 features have a resolution less than the initial resolution and a number of channels greater than the initial number of channels.

This process is repeated multiple times, and then the process is reversed. That is, the down-sampled features 1725 are up-sampled using up-sampling process 1730 to obtain up-sampled features 1735. The up-sampled features 1735 can be combined with intermediate features 1715 having the same resolution and number of channels via a skip connection 1740. These inputs are processed using a final neural network layer 1745 to produce output features 1750. In some cases, the output features 1750 have the same resolution as the initial resolution and the same number of channels as the initial number of channels.

In some cases, U-Net 1700 takes additional input features to produce conditionally generated output. For example, the additional input features could include a vector representation of an input prompt, an image generation prompt, or a reference image. The additional input features can be combined with the intermediate features 1715 within the neural network at one or more layers. For example, a cross-attention module can be used to combine the additional input features and the intermediate features 1715.

### Inference: Conditional Generation

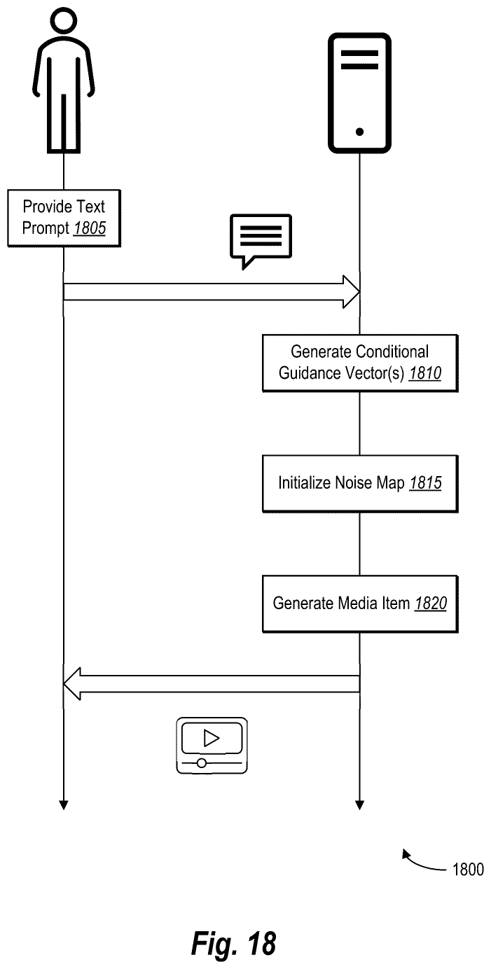

FIG. 18 shows an example of a method 1800 for conditional media generation according to aspects of the present disclosure. In some examples, method 1800 describes an operation of the diffusion model 208 described herein such as an application of the guided diffusion model 1600 described with reference to FIG. 16. In some examples, these operations are performed by a system including a processor executing a set of codes to control functional elements of an apparatus such as the media generation model described in FIG. 16.

Additionally, or alternatively, steps of the method 1800 may be performed using special-purpose hardware. Generally, these operations are performed according to the methods and processes described in accordance with aspects of the present disclosure. In some cases, the operations described herein are composed of various sub-steps or are performed in conjunction with other operations.

At operation 1805, a user provides a text prompt (e.g., the text prompt 204) describing content to be included in a generated custom animation. For example, the custom animation generation system may provide the prompt “melting pistachio ice cream.” In some examples, guidance can be provided in a form other than text, such as via an image, a reference image, a sketch, or a layout.

At operation 1810, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1815, a noise map is initialized that includes random noise. The noise map may be in a pixel space or a latent space. By initializing a media item with random noise, different variations of a media item including the content described by the conditional guidance can be generated.

At operation 1820, the system generates a media item based on the noise map and the conditional guidance vector. For example, the media item may be generated using a reverse diffusion process as described with reference to FIG. 16.

### Inference: Reverse Diffusion

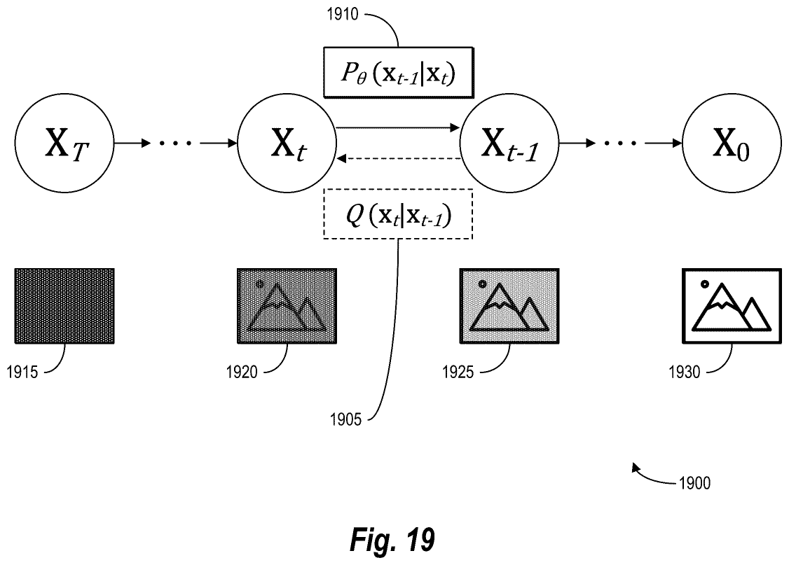

FIG. 19 shows a diffusion process 1900 according to aspects of the present disclosure. In some examples, diffusion process 1900 describes an operation of the diffusion model 208 described herein, such as the reverse diffusion process 1625 of guided diffusion model 1600 described with reference to FIG. 16.

As described above with reference to FIG. 16, using a diffusion model can involve both a forward diffusion process 1905 for adding noise to a media item (or features in a latent space) and a reverse diffusion process 1910 for denoising the media item (or features) to obtain a denoised media item. The forward diffusion process 1905 can be represented as q(xₜ|xₜ₋₁), and the reverse diffusion process 1910 can be represented as p(xₜ₋₁|xₜ). In some cases, the forward diffusion process 1905 is used during training to generate media items with successively greater noise, and a neural network is trained to perform the reverse diffusion process 1910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1910, the model begins with noisy data x_{T}, such as a noisy media item 1915 and denoises the data to obtain the p(xₜ₋₁|xₜ). At each step t−1, the reverse diffusion process 1910 takes xₜ, such as first intermediate media item 1920, and t as input. Here, t represents a step in the sequence of transitions associated with different noise levels, The reverse diffusion process 1910 outputs xₜ₋₁, such as second intermediate media item 1925 iteratively until x_{T} reverts back to x₀, the original media item 1930. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

### Training: Machine Learning

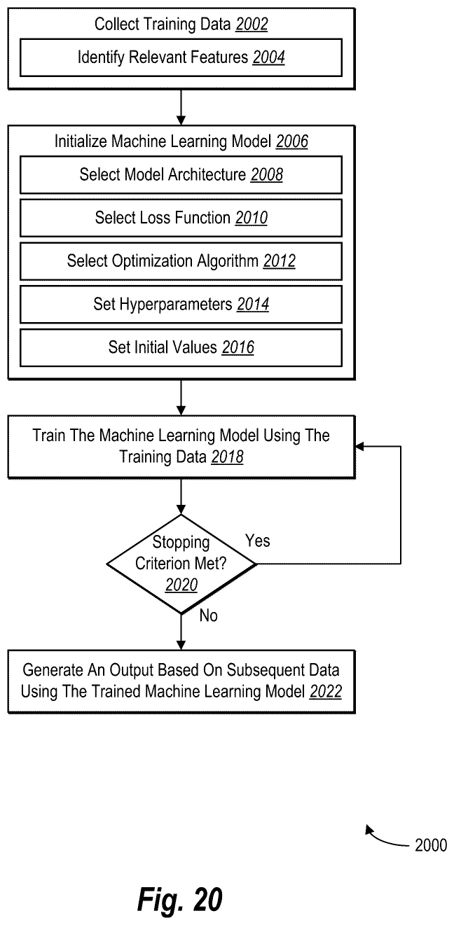

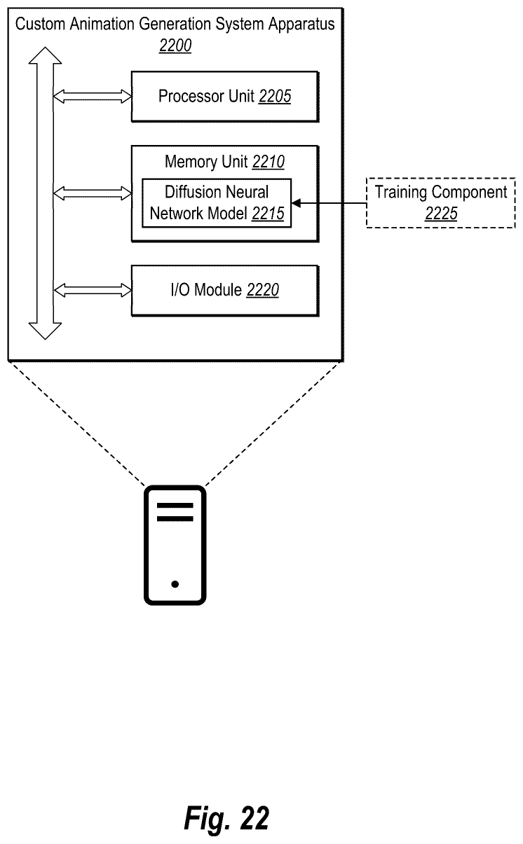

FIG. 20 is a flow diagram depicting an algorithm as a step-by-step procedure for procedure 2000 in an example implementation of operations performable for training a machine-learning model. In some embodiments, the procedure 2000 describes an operation of the training component 2225 described for configuring the diffusion model 208 as described with reference to FIG. 22. The procedure 2000 provides one or more examples of generating training data, use of the training data to train a machine-learning model, and use of the trained machine-learning model to perform a task.

To begin, in this example, a machine-learning system collects training data (block 2002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify relevant features that are relevant (block 2004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 2006). Initialization of the machine-learning model includes selecting a model architecture (block 2008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2210). The loss function is utilized to measure a difference between an output of the machine-learning model (i.e., predictions) and target values (e.g., as expressed by the training data) to be used to train the machine-learning model. Additionally, an optimization algorithm is selected (block 2212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2216) examples of which includes initializing weights and biases of nodes to improve efficiency in training and computational resources consumption as part of training. Hyperparameters are also set (block 2214) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 820), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 820), the procedure 2000 continues training of the machine-learning model using the training data (block 2218) in this example.

If the stopping criterion is met (“yes” from decision block 820), the trained machine-learning model is then utilized to generate an output based on subsequent data (block 822). The trained machine-learning model, for instance, is trained to perform a task as described above and therefore once trained is configured to perform that task based on subsequent data received as an input and processed by the machine-learning model.

### Training: Diffusion Training

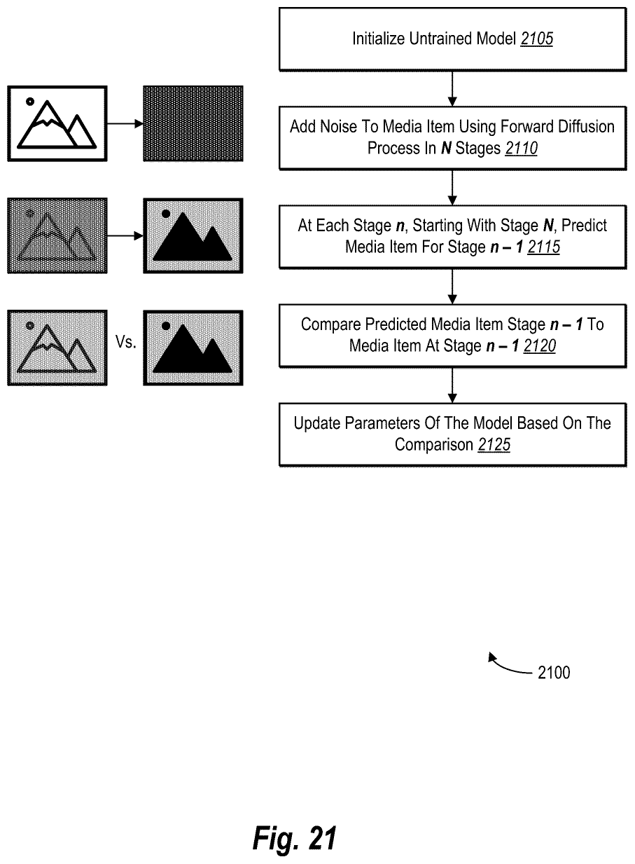

FIG. 21 shows an example of a method 2100 for training a diffusion model according to aspects of the present disclosure. In some embodiments, the method 2100 describes an operation of the training component 2225 described for configuring the diffusion neural network model 2215 as described with reference to FIG. 22. The method 2100 represents an example for training a reverse diffusion process as described above with reference to FIG. 16. In some examples, these operations are performed by a system including a processor executing a set of codes to control functional elements of an apparatus, such as the guided diffusion model described in FIG. 16.

Additionally, or alternatively, certain processes of method 2100 may be performed using special-purpose hardware. Generally, these operations are performed according to the methods and processes described in accordance with aspects of the present disclosure. In some cases, the operations described herein are composed of various sub-steps or are performed in conjunction with other operations.

At operation 2105, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2110, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2115, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2120, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 2125, the system updates parameters of the model based on the comparison. For example, parameters of a U-Net may be updated using gradient descent. Time-dependent parameters of the Gaussian transitions can also be learned.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 22 shows an example of the custom animation generation system apparatus 2200 according to aspects of the present disclosure. The custom animation generation system apparatus 2200 may include an example of, or aspects of, the guided diffusion model described with reference to FIG. 12, FIG. 16, or the U-Net described with reference to FIG. 14 and FIG. 4. In some embodiments, the custom animation generation system apparatus 2200 includes processor unit 2205, memory unit 2210, the diffusion model 2215, I/O module 2220, and training component 2225. Training component 2225 updates parameters of the media generation diffusion model 2215 stored in the memory unit 2210. In some examples, the training component 2225 is located outside the custom animation generation system apparatus 2200.

The processor unit 2205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, the processor unit 2205 is configured to operate a memory array using a memory controller. In other cases, a memory controller is integrated into the processor unit 2205. In some cases, the processor unit 2205 is configured to execute computer-readable instructions stored in the memory unit 2210 to perform various functions. In some aspects, the processor unit 2205 includes special purpose components for modem processing, baseband processing, digital signal processing, or transmission processing. According to some aspects, the processor unit 2205 comprises one or more processors described with reference to FIG. 22.

The memory unit 2210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of the processor unit 2205 to perform various functions described herein.

In some cases, the memory unit 2210 includes a basic input/output system (BIOS) that controls basic hardware or software operations, such as an interaction with peripheral components or devices. In some cases, the memory unit 2210 includes a memory controller that operates memory cells of the memory unit 2210. For example, the memory controller may include a row decoder, column decoder, or both. In some cases, memory cells within the memory unit 2210 store information in the form of a logical state. According to some aspects, the memory unit 2210 is an example of the memory unit 2210 described with reference to FIG. 22.

According to some aspects, the custom animation generation system apparatus 2200 uses one or more processors of the processor unit 2205 to execute instructions stored in memory unit 2210 to perform functions described herein. For example, the custom animation generation system apparatus 2200 may execute instructions to generate an image generation prompt. In some cases, the custom animation generation system apparatus 2200 may execute instructions to cause a media generation diffusion model to generate a custom animation. In some cases, the custom animation generation system apparatus 2200 may execute instructions to cause an image refinement model to generate a custom animation. In some cases, the custom animation generation system apparatus 2200 may execute instructions to cause a custom animation preview model to generate and/or display a preview image for a custom animation.

The memory unit 2210 may include the media generation diffusion model 2215 trained to receive, via an interaction with a user device, a text prompt to generate a custom animation portraying one or more elements and generate an image generation prompt from the text prompt. Furthermore, the memory unit 2210 may include the media generation diffusion model 2215 trained to generate, utilizing a media generation diffusion model, from the image generation prompt, a custom animation depicting elements from a text prompt. In some cases, the memory unit 2210 may include the media generation diffusion model 2215 trained to refine the custom animation to generate the custom animation. For example, after training, the media generation diffusion model 2215 may perform inferencing operations as described herein above.

In some embodiments, the media generation diffusion model 2215 is an Artificial neural network (ANN) such as the guided diffusion model described with reference to FIG. 16 and the U-Net described with reference to FIG. 17. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the media generation diffusion model 2215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 2225 may train the media generation diffusion model 2215. For example, parameters of the media generation diffusion model 2215 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 20 and 21). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the media generation diffusion model 2215 can be used to make predictions on new, unseen data (i.e., during inference).

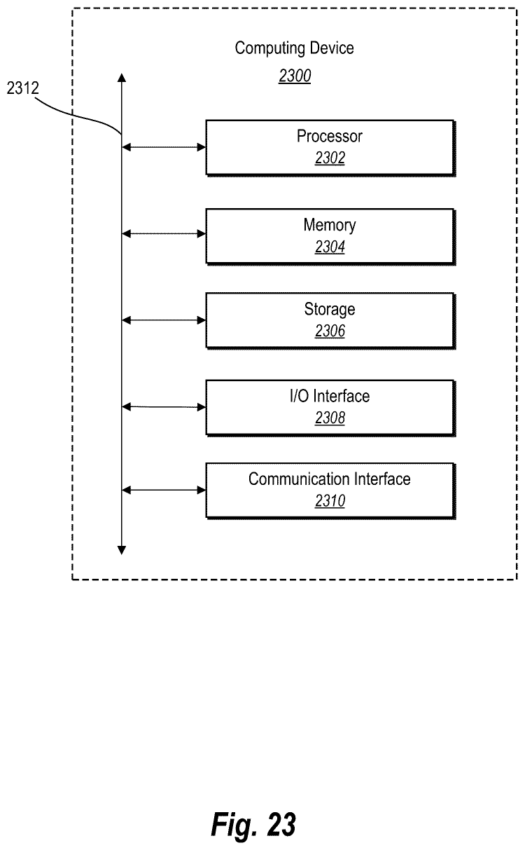

I/O module 2220 receives inputs from and transmits outputs of the custom animation generation system apparatus 2200 to other devices or users. For example, I/O module 2220 receives inputs for the media generation diffusion model 2215 and transmits outputs of the media generation diffusion model 2215. According to some aspects, I/O module 2220 is an example of the I/O interfaces 2308 described with reference to FIG. 23.

FIG. 23 illustrates a block diagram of an example computing device 2300 that may be configured to perform one or more of the processes described above. One will appreciate that one or more computing devices, such as the computing device 2300 may represent the computing devices described above (e.g., server device(s) 106, client device(s) 108, and computing device 2300). In one or more embodiments, the computing device 2300 may be a mobile device (e.g., a mobile telephone, a smartphone, a PDA, a tablet, a laptop, a camera, a tracker, a watch, a wearable device, etc.). In some embodiments, the computing device 2300 may be a non-mobile device (e.g., a desktop computer or another type of client device). Further, the computing device 2300 may be a server device that includes cloud-based processing and storage capabilities.

As shown in FIG. 23, the computing device 2300 can include one or more processor(s) 2302, memory 2304, a storage device 2306, input/output interfaces 2308 (or “I/O interfaces 2308”), and a communication interface 2310, which may be communicatively coupled by way of a communication infrastructure (e.g., bus 2312). While the computing device 2300 is shown in FIG. 23, the components illustrated in FIG. 23 are not intended to be limiting. Additional or alternative components may be used in other embodiments. Furthermore, in certain embodiments, the computing device 2300 includes fewer components than those shown in FIG. 23. Components of the computing device 2300 shown in FIG. 23 will now be described in additional detail.

In particular embodiments, the processor(s) 2302 includes hardware for executing instructions, such as those making up a computer program. As an example, and not by way of limitation, to execute instructions, the processor(s) 2302 may retrieve (or fetch) the instructions from an internal register, an internal cache, memory 2304, or a storage device 2306 and decode and execute them.

The computing device 2300 includes memory 2304, which is coupled to the processor(s) 2302. The memory 2304 may be used for storing data, metadata, and programs for execution by the processor(s). The memory 2304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 2304 may be internal or distributed memory.

The computing device 2300 includes a storage device 2306 includes storage for storing data or instructions. As an example, and not by way of limitation, the storage device 2306 can include a non-transitory storage medium described above. The storage device 2306 may include a hard disk drive (HDD), flash memory, a Universal Serial Bus (USB) drive or a combination these or other storage devices.

As shown, the computing device 2300 includes one or more I/O interfaces 2308, which are provided to allow a user to provide input to (such as user strokes), receive output from, and otherwise transfer data to and from the computing device 2300. These I/O interfaces 2308 may include a mouse, keypad or a keyboard, a touch screen, camera, optical scanner, network interface, modem, other known I/O devices or a combination of such I/O interfaces 2308. The touch screen may be activated with a stylus or a finger.

The I/O interfaces 2308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 2308 are configured to provide graphical data to a display for presentation to a user. The graphical data may be representative of one or more graphical user interfaces and/or any other graphical content as may serve a particular implementation.

The computing device 2300 can further include a communication interface 2310. The communication interface 2310 can include hardware, software, or both. The communication interface 2310 provides one or more interfaces for communication (such as, for example, packet-based communication) between the computing device and one or more other computing devices or one or more networks. As an example, and not by way of limitation, communication interface 2310 may include a network interface controller (NIC) or network adapter for communicating with an Ethernet or other wire-based network or a wireless NIC (WNIC) or wireless adapter for communicating with a wireless network, such as a WI-FI. The computing device 2300 can further include a bus 2312. The bus 2312 can include hardware, software, or both that connects components of computing device 2300 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
receiving a style prompt;
receiving a coarse animation prompt;
generating, utilizing a media generation model, a custom animation having a structure and a timing of the coarse animation prompt and a style informed by the style prompt; and
providing the custom animation for display via a graphical user interface.

2. The method of claim 1, further comprising:
generating, utilizing an edge detection model, a plurality of edge maps from frames of the coarse animation prompt;
generating, utilizing an encoder, a structural embedding from the plurality of edge maps; and
denoising, utilizing the media generation model, a noise input conditioned upon the style prompt and the coarse animation prompt by injecting the structural embedding into layers of the media generation model utilizing a structure control branch.

3. The method of claim 1, wherein generating the custom animation comprises by:
denoising, utilizing the media generation model, a noise input conditioned upon the style prompt and the coarse animation prompt to generate denoised frames; and
combining the denoised frames.

4. The method of claim 1, further comprising:
generating, utilizing a depth estimation model, a plurality of depth maps from frames of the coarse animation prompt; and
generating, utilizing an encoder, a structural embedding from the plurality of depth maps;
wherein denoising, utilizing the media generation model, the noise input conditioned upon the style prompt and the coarse animation prompt comprises injecting the structural embedding into layers of the media generation model utilizing a structure control branch.

5. The method of claim 4, wherein generating the custom animation comprises generating a three-dimensional custom animation.

6. The method of claim 1, wherein:
receiving the style prompt comprises receiving a stylized image; and
denoising, utilizing the media generation model, the noise input conditioned upon the style prompt comprises generating the denoised frames to have a style of the stylized image.

7. The method of claim 1, wherein:
receiving the style prompt comprises receiving a text prompt; and
denoising, utilizing the media generation model, the noise input conditioned upon the style prompt comprises generating the denoised frames to have a style informed by the text prompt.

8. The method of claim 1, wherein:
receiving the coarse animation prompt comprises receiving a black and white animation video; and
generating the custom animation comprises generating the custom animation to have a resolution higher than a resolution of the coarse animation prompt.

9. The method of claim 1, wherein:
receiving the style prompt comprises receiving a stylized image and a text prompt; and
denoising, utilizing the media generation model, the noise input conditioned upon the style prompt comprises generating the denoised frames to have a style informed by the stylized image and the text prompt.

10. The method of claim 1, further comprising receiving, via a graphical user interface, an indication of a structure control strength, wherein generating, utilizing the media generation model, the custom animation having the structure of the coarse animation prompt and the style informed by the style prompt comprises giving more weight to one of the structure of the coarse animation prompt or the style prompt based on the indication of the structure control strength.

11. The method of claim 1, further comprising receiving, via a graphical user interface, an indication of a spatial location within the coarse animation prompt, wherein generating, utilizing the media generation model, the custom animation having the structure of the coarse animation prompt and the style informed by the style prompt comprises giving more weight the structure of the coarse animation prompt than the style prompt in the spatial location.

12. A non-transitory computer-readable medium comprising instructions that, when executed by at least one processor, cause the at least one processor to perform operations comprising:
receiving an animation generation request comprising a text prompt, an image prompt, and a coarse animation prompt;
generating, utilizing a media generation model, a custom animation comprising a structure of the coarse animation prompt and a style informed by the text prompt and the image prompt; and
providing the custom animation for display via a graphical user interface.

13. The non-transitory computer-readable medium of claim 12, wherein:
the operations further comprise:
generating, utilizing a depth estimation model, a plurality of depth maps from frames of the coarse animation prompt;
generating, utilizing an encoder, a structural embedding from the plurality of depth maps; and
denoising, utilizing the media generation model, a noise input conditioned upon the text prompt, the image prompt, and the coarse animation prompt by injecting the structural embedding into layers of the media generation model utilizing a structure control branch.

14. The non-transitory computer-readable medium of claim 12, wherein the operations further comprise:
receiving an indication of a spatial location within the coarse animation prompt; and
denoising, utilizing the media generation model, a noise input conditioned upon the text prompt, the image prompt, and the coarse animation prompt to generate denoised frames having the structure of the coarse animation prompt and the style informed by the text prompt and the image prompt by giving more weight to the structure of the coarse animation prompt in the spatial location during denoising and giving more weight to the style informed by the text prompt and the image prompt in locations other than the spatial location.

15. The non-transitory computer-readable medium of claim 12, wherein the operations further comprise:
receiving an indication a subset of frames within the coarse animation prompt; and
denoising, utilizing the media generation model, a noise input conditioned upon the text prompt, the image prompt, and the coarse animation prompt to generate denoised frames having the structure of the coarse animation prompt and the style informed by the text prompt and the image prompt by giving more weight to the structure of the coarse animation prompt for subset of frames during denoising and giving more weight to the style informed by the text prompt and the image prompt for frames other than the subset of frames.

16. The non-transitory computer-readable medium of claim 12, wherein receiving the animation generation request comprising the coarse animation prompt comprises receiving a two-dimensional video.

17. A system comprising:
one or more memory devices; and
one or more processors coupled to the one or more memory devices that cause the system to perform operations comprising:
receiving a style prompt;
receiving a coarse animation prompt;
generating, utilizing a media generation model, a custom animation having a structure and a timing of the coarse animation prompt and a style informed by the style prompt; and
providing the custom animation for display via a graphical user interface.

18. The system of claim 17, wherein generating, utilizing the media generation model, the custom animation comprises:
extracting, utilizing a depth estimation model, depth maps from a plurality of frames of the coarse animation prompt;
generating, utilizing an encoder, one or more structural embeddings from the depth maps;
denoising, utilizing the media generation model, a noise input; and
during denoising, utilizing a structure control branch, injecting the one or more structural embeddings into layers of the media generation model.

19. The system of claim 17, wherein receiving the style prompt comprises receiving a text prompt and an image prompt.

20. The system of claim 17, wherein generating, utilizing the media generation model, the custom animation comprises utilizing a diffusion transformer model to generate the custom animation to have a length of the video of the coarse animation prompt and a resolution greater than a resolution of the coarse animation prompt.
